(19) United States
(12) Patent Application Publication
(10) Pub. No.: US 2026/0320712 A1
(43) Pub. Date: Oct. 15, 2026

(54) System and Method for User Interface and Experience Optimized for Legal Outcome Prediction Utilizing Interactive Calculators, Advanced Visualization, and Dynamic Analytics

(71) Applicant: Canotera LTD, Haifa (IL)

(72) Inventors: David H. Silver, Poughkeepsie, NY (US); Tal Knafo, Haifa (IL)

(73) Assignee: Canotera LTD, Haifa (IL)

(21) Appl. No.: 19/444,898

(22) Filed: Jan. 9, 2026

Related U.S. Application Data
(60) Provisional application No. 63/744,477, filed on Jan. 13, 2025.

(51) Int. Cl. G06Q 50/18

(52) U.S. Cl. CPC G06Q 50/18

(57) ABSTRACT

A system and method for processing electronic documents to generate a prediction output within an interactive calculator interface is presented. The method includes receiving electronic documents; generating structured matter data based on the electronic documents; generating a calculator definition based on the structured matter data, wherein the calculator definition specifies a plurality of input fields, constraint for the plurality of input fields, and output visualization binding; rendering the interactive calculator interface based on the calculator definition; receiving, through the interactive calculator interface, user-provided values for at least a subset of the plurality of input fields; constructing a model feature representation based on the user-provided values and the structured matter data; generating a model output; calibrating the model output using a calibration mapping; and generating the prediction output based on the calibrated model output, the prediction output being presented within the interactive calculator interface according to the output visualization binding.

### CROSS REFERENCE TO RELATED APPLICATION

This application claims the benefit of U.S. Provisional Application No. 63/744,477, filed Jan. 13, 2025, the contents of which are hereby incorporated by reference.

### TECHNICAL FIELD

The present disclosure relates generally to processing case-related electronic documents and, more particularly, to systems and methods that generate prediction output for a legal matter by deriving structured legal matter data and derived features from the case-related electronic documents, binding user-provided values received through an interactive calculator interface to a model feature representation, generating model output via a predictive model, transforming the model output into a calibrated prediction output using cohort-based calibration mapping, and presenting the prediction output within the interactive calculator interface using output visualization bindings defined by a validated calculator definition.

### BACKGROUND

Enterprises such as law firms and legal service providers commonly manage legal matters using heterogeneous data sources. While these sources may contain information relevant to assessing outcomes, exposure, timing, and strategy, the information is often distributed across formats and repositories and may be difficult to normalize into a consistent representation suitable for computational analysis. Moreover, conventional analytics tools may generate scores or reports without providing defensible lineage to underlying source materials, without enforcing constraints and consistency rules during interactive evaluation, and without presenting results in a way that supports iterative what-if exploration and controlled collaboration. Accordingly, there is a need for systems that can transform case-related electronic documents into structured legal matter data with provenance, support interactive data binding and validated computation through calculator definitions, and generate prediction output based on calibrated prediction output while maintaining governance artifacts sufficient to support review, auditability, and controlled sharing.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that, in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving a plurality of legal documents as electronic files, where the plurality of legal documents are associated with a legal matter. The method may also include generating structured legal matter data based on the received plurality of legal documents, where the structured legal matter data includes canonical entities; generating derived features by applying a jurisdiction-aware legal ontology to the received plurality of legal documents; generating a calculator definition for the legal matter based on the structured legal matter data, where the calculator definition specifies a plurality of input fields, at least one constraint for the plurality of input fields, at least one computational relationship among the plurality of input fields, and at least one output visualization binding; rendering the interactive calculator interface based on the calculator definition; receiving, through the interactive calculator interface, user-provided values for at least a subset of the plurality of input fields; constructing a model feature representation based on the user-provided values and the structured legal matter data; generating a model output for the legal matter, via a predictive model, based on the model feature representation; transforming the model output into a calibrated prediction output using a calibration mapping selected based on at least a subset of the structured legal matter data; and generating the prediction output based on the calibrated prediction output, the prediction output being presented within the interactive calculator interface according to the at least one output visualization bindings. Other embodiments of this aspect include corresponding computer systems, apparatus, and computer programs recorded on one or more computer storage devices, each configured to perform the actions of the methods.

Implementations may include one or more of the following features. The method may include: normalizing the plurality of legal documents into normalized records that conform to a normalized intake schema, where the normalized intake schema specifies field names, field types, permitted value ranges, required-field constraints, and inter-field may include rules applied during normalization; and associating the normalized records with the legal matter; identifying candidate entities using a matter-entity model, where the matter-entity model receives text blocks, captions, signatures, and header metadata derived from the plurality of legal documents as inputs and outputs text-span labels and relationship records, where the candidate entities are identified based on the outputs; and promoting the candidate entities into the canonical entities by assigning persistent identifiers and jurisdictional attributes, where the canonical entities include parties, counsel, courts, judicial officers, claims, statutes, venues, procedural events, and docket identifiers; associating the canonical entities to ontology classes and relations defined by the jurisdiction-aware legal ontology, where at least one associated canonical entity includes courts and venues; standardizing jurisdictional attributes with the at least one associated canonical entity, where the jurisdictional attributes include forum identifiers and division identifiers; validating that each associated canonical entity satisfies required attributes specified for the ontology class; and recording provenance links that associate the associated canonical entities, the standardized jurisdictional attributes and the validated associated canonical entities with the plurality of legal documents; selecting a pre-defined calculator template; and instantiating the pre-defined calculator template for the legal matter by binding at least a first subset of the plurality of input fields to the canonical entities and binding at least a second subset of the plurality of input fields to the derived features; receiving a user request, where the user request includes a calculator objective; generating the calculator definition based on the user request; aligning a first subset of terminology in the user request to the canonical entities; and aligning a second subset of terminology in the user request to ontology classes represented by the jurisdiction-aware legal ontology; generating a structured calculator representation using a language-to-calculator model, where the user request and the structured legal matter data are inputs to the language-to-calculator model, the structured calculator representation enumerates candidate input fields; and determining the plurality of input fields based on at least a subset of the candidate input fields; presenting constraint feedback by evaluating the at least one constraint against current user-provided values and displaying a constraint violation indicator responsive to a detected constraint violation; and generating an explanation package associated with the prediction output, where the explanation package includes contributing factors and contribution magnitudes mapped to the plurality of input fields and the derived features. Implementations of the described techniques may include hardware, a method or process, or a computer tangible medium.

In one general aspect, non-transitory computer-readable medium may include one or more instructions that, when executed by one or more processing circuitries of a device, cause the device to receive a plurality of legal documents as electronic files, where the plurality of legal documents are associated with a legal matter. Medium may furthermore include generate structured legal matter data based on the received plurality of legal documents, where the structured legal matter data includes canonical entities; generate derived features by applying a jurisdiction-aware legal ontology to the received plurality of legal documents; generate a calculator definition for the legal matter based on the structured legal matter data, where the calculator definition specifies a plurality of input fields, at least one constraint for the plurality of input fields, at least one computational relationship among the plurality of input fields, and at least one output visualization binding; render the interactive calculator interface based on the calculator definition; receive, through the interactive calculator interface, user-provided values for at least a subset of the plurality of input fields; construct a model feature representation based on the user-provided values and the structured legal matter data; generate a model output for the legal matter, via a predictive model, based on the model feature representation; transform the model output into a calibrated prediction output using a calibration mapping selected based on at least a subset of the structured legal matter data; and generate the prediction output based on the calibrated prediction output, the prediction output being presented within the interactive calculator interface according to the at least one output visualization bindings. Other embodiments of this aspect include corresponding computer systems, apparatus, and computer programs recorded on one or more computer storage devices, each configured to perform the actions of the methods.

In one general aspect, the system may include a processing circuitry. System may also include a memory, the memory containing instructions that, when executed by the processing circuitry, configure the system to receive a plurality of legal documents as electronic files, where the plurality of legal documents are associated with a legal matter; generate structured legal matter data based on the received plurality of legal documents, where the structured legal matter data includes canonical entities; generate derived features by applying a jurisdiction-aware legal ontology to the received plurality of legal documents; generate a calculator definition for the legal matter based on the structured legal matter data, where the calculator definition specifies a plurality of input fields, at least one constraint for the plurality of input fields, at least one computational relationship among the plurality of input fields, and at least one output visualization binding; render the interactive calculator interface based on the calculator definition; receive, through the interactive calculator interface, user-provided values for at least a subset of the plurality of input fields; construct a model feature representation based on the user-provided values and the structured legal matter data; generate a model output for the legal matter, via a predictive model, based on the model feature representation; transform the model output into a calibrated prediction output using a calibration mapping selected based on at least a subset of the structured legal matter data; and generate the prediction output based on the calibrated prediction output, the prediction output being presented within the interactive calculator interface according to the at least one output visualization bindings. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: normalize the plurality of legal documents into normalized records that conform to a normalized intake schema, where the normalized intake schema specifies field names, field types, permitted value ranges, required-field constraints, and inter-field may include rules applied during normalization; and associate the normalized records with the legal matter.

The system where the memory contains further instructions which when executed by the processing circuitry further configure the system to: identify candidate entities using a matter-entity model, where the matter-entity model receives text blocks, captions, signatures, and header metadata derived from the plurality of legal documents as inputs and outputs text-span labels and relationship records, where the candidate entities are identified based on the outputs; and promote the candidate entities into the canonical entities by assigning persistent identifiers and jurisdictional attributes, where the canonical entities include parties, counsel, courts, judicial officers, claims, statutes, venues, procedural events, and docket identifiers.

The system where the memory contains further instructions which when executed by the processing circuitry further configure the system to: associate the canonical entities to ontology classes and relations defined by the jurisdiction-aware legal ontology, where at least one associated canonical entity includes courts and venues; standardize jurisdictional attributes with the at least one associated canonical entity, where the jurisdictional attributes include forum identifiers and division identifiers; validate that each associated canonical entity satisfies required attributes specified for the ontology class; and record provenance links that associate the associated canonical entities, the standardized jurisdictional attributes and the validated associated canonical entities with the plurality of legal documents.

The system where the memory contains further instructions which when executed by the processing circuitry further configure the system to: select a pre-defined calculator template; and instantiate the pre-defined calculator template for the legal matter by binding at least a first subset of the plurality of input fields to the canonical entities and binding at least a second subset of the plurality of input fields to the derived features.

The system where the memory contains further instructions which when executed by the processing circuitry further configure the system to: receive a user request, where the user request includes a calculator objective; generate the calculator definition based on the user request; align a first subset of terminology in the user request to the canonical entities; and align a second subset of terminology in the user request to ontology classes represented by the jurisdiction-aware legal ontology.

The system where the memory contains further instructions which when executed by the processing circuitry further configure the system to: generate a structured calculator representation using a language-to-calculator model, where the user request and the structured legal matter data are inputs to the language-to-calculator model, the structured calculator representation enumerates candidate input fields; and determine the plurality of input fields based on at least a subset of the candidate input fields.

The system where the memory contains further instructions, which when executed by the processing circuitry further configure the system to present constraint feedback by evaluating the at least one constraint against current user-provided values and displaying a constraint violation indicator responsive to a detected constraint violation.

The system where the memory contains further instructions which when executed by the processing circuitry further configure the system to generate an explanation package associated with the prediction output, where the explanation package includes contributing factors and contribution magnitudes mapped to the plurality of input fields and the derived features. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example system diagram of a computing environment, utilized to describe an embodiment.

FIG. 2 is an example data flow diagram between calculator fields, a binding service, model features, and prediction outputs, in accordance with an embodiment.

FIG. 3 is an example process flow diagram illustrating a what-if and sensitivity evaluation loop with calibration and conformal readouts, in accordance with an embodiment.

FIG. 4 is an example user interface visualization diagram, in accordance with an embodiment.

FIG. 5 is an example workflow diagram associated with a calculator scenario, in accordance with an embodiment.

FIG. 6 is an example user interface depiction illustrating an accessibility structure, in accordance with an embodiment.

FIG. 7 is an example governance workflow diagram, in accordance with an embodiment.

FIG. 8 is an example flowchart of a method for processing case-related electronic documents to generate a prediction output, implemented in accordance with an embodiment.

FIG. 9 is an example schematic diagram of a data ingestion pipeline 110 according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

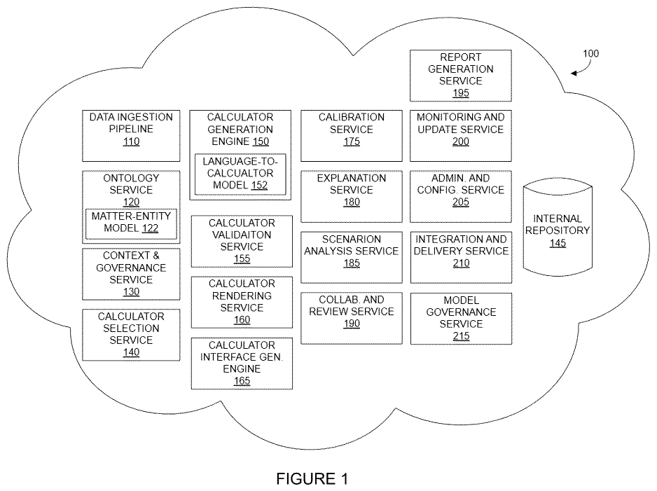

FIG. 1 is an example system diagram of a computing environment, in accordance to an embodiment.

In some embodiments, an analytics system 100 includes a data ingestion pipeline 110, an ontology service 120, a matter-entity model 122, a context & governance service 130, a calculator selection service 140, an internal repository 145, a calculator generation engine 150, a language-to-calculator model 152, a calculator validation service 155, a calculator rendering service 160, a calculator interface generation engine 165, a feature binding service 170, a calibration service 175, an explanation service 180, a scenario analysis service 185, a collaboration and review service 190, a report generation service 195, a monitoring and update service 200, an administration and configuration service 205, an integration and delivery service 210 and a model governance service 215 In some embodiments, a data ingestion pipeline 110 is configured to initialize a matter-ingestion session and to persist a session object that remains addressable throughout intake.

In some embodiments, the data ingestion pipeline 110 is configured to authenticate a requesting principal through an enterprise identity system, to issue a time-boxed session identifier, to derive access scope attributes from policy, to write the session object with access attributes to the context & governance service 130, a combination thereof and the like.

In some embodiments, the data ingestion pipeline 110 is further configured to register declared source systems and to emit an ingestion itinerary that enumerates endpoints, source position indicators that identify a retrieval boundary within a source system, pacing limits, authentication methods, delivery preferences, a combination thereof and the like.

In some embodiments, the data ingestion pipeline 110 is configured to extract records from enterprise systems such as document-management repositories, docket and calendar feeds, research services, e-billing platforms, email stores, calendar stores, file shares, a combination thereof and the like.

In some embodiments, the data ingestion pipeline 110 is configured to request a time-limited connection handle, to negotiate source position indicators with source endpoints, to subscribe to event notification messages transmitted by a source system responsive to a change, and to schedule extraction jobs under rate and concurrency budgets, a combination thereof and the like.

In some embodiments, the data ingestion pipeline 110 is configured to parse and normalize each extraction job.

In some embodiments, the parsing and normalization is based on a stream-based transfer in which payload segments are processed as received, by segmenting and parsing source-specific formats, converting values to conform to the normalized intake schema, computing cryptographic digest values computed over record contents for de-duplication, reconciling conflicting values under source ranking rules that resolve conflicting values based on a predefined source order, a combination thereof and the like.

In some embodiments, raw secrets remain confined to a credential mediation service that resolves a connection handle using secrets stored in a secrets repository storing encrypted credentials. In some embodiments, the secrets repository is the internal repository 145.

In some embodiments, the data ingestion pipeline 110 is configured to normalize extracted payloads into normalized records that conform to a normalized intake schema.

In some embodiments, the normalized intake schema specifies field names, field types, permitted value ranges, required-field constraints, inter-field consistency rules used during normalization, a combination thereof and the like.

In some embodiments, normalization includes parsing source-specific formats, computing cryptographic digest values computed over record contents to de-duplicate normalized records, reconciling conflicting field values using source ranking rules that resolve conflicting values based on a predefined source order, converting values to conform to schema constraints, and attaching lineage to connector invocations, a combination thereof and the like.

In some embodiments, the data ingestion pipeline 110 is configured to group normalized records into a plurality of batches.

In some embodiments, a batch among the plurality of batches is a logically bounded unit produced by a single extraction job and includes records derived from a specific source endpoint over a contiguous extraction window, from a single event notification message, from a defined commit range, a combination thereof and the like.

In some embodiments, each batch among the plurality of batches includes a batch manifest that lists a session identifier, a source connector identifier, a source endpoint, source-position start and stop indicators, extraction-window start and stop timestamps, a record count, record-level cryptographic digest values computed over record contents, a batch integrity value computed over the batch contents and the batch manifest, and a version identifier, a combination thereof and the like.

In some embodiments, the plurality of batches are stored in the internal repository 145. In some embodiments, storing the plurality of batches includes using a write-once versioning policy that stores each batch as an additional version without overwriting a prior version, such that replaying an identical batch identified by the batch integrity value and the record-level digest values does not create a second logically distinct stored batch.

In some embodiments, an ontology service 120 is configured to identify candidate entities from structured fields in the plurality of batches, from outputs produced by a matter-entity model 122, a combination thereof and the like.

In some embodiments, an entity mention is a span in a structured field or text that indicates a party name, a judge name, a statute citation, a venue string, a procedural event label, a docket identifier, a combination thereof and the like.

In some embodiments, the candidate entities correspond to parties, counsel, courts, judicial officers, claims, statutes, venues, procedural events, docket identifiers, a combination thereof and the like.

The ontology service 120 is configured to construct each candidate entity by extracting entity mentions from structured fields, by applying normalization rules and queries to reference registries that store canonical court identifiers and judicial-officer identifiers, and by merging duplicate mentions using similarity scores computed from string distance metrics, phonetic encodings, and normalized tokens, a combination thereof and the like, together with jurisdictional mapping tables that map source-specific labels to standardized identifiers.

The ontology service 120 is further configured to promote a candidate entity to a canonical entity by assigning a persistent identifier, attaching jurisdictional attributes, and recording provenance to the normalized intake schema, a combination thereof and the like.

In some embodiments, the matter-entity model 122 receives normalized text blocks, captions, signatures, and header metadata, a combination thereof and the like, and outputs text-span labels that associate a label with a character range and a label type, relationship records that link two labeled spans together with a relationship type, and confidence values, a combination thereof and the like.

In some embodiments, an ontology service 120 is configured to align canonical entities to a jurisdiction-aware legal ontology.

In some embodiments, the alignment includes applying ontology rule tables and jurisdictional mapping tables to attributes on the canonical entities, associating canonical entities to ontology classes and relations, resolving forum and division codes to standardized identifiers, validating prerequisite attributes for each class, and recording provenance links to underlying mentions and normalized records, a combination thereof and the like.

In some embodiments, features are derived by evaluating ontology rules against aligned canonical entities, traversing relations among canonical entities defined in the ontology, computing aggregates across events and roles, projecting dates into procedural stages, assigning flags, assigning numeric indicators required by downstream calculators, a combination thereof and the like.

In some embodiments, the ontology service 120 is configured to generate a timeline representation of procedural events with stage labels for a legal matter based on normalized records and canonical entities. In some embodiments, generating the timeline representation includes identifying, from the normalized records, a plurality of procedural events that occurred in association with the legal matter, where a procedural event includes a filing event, a service event, a hearing event, a motion event, an order event, a scheduling event, a deadline event, a conference event, a disposition event, a settlement event, a judgment event, a combination thereof and the like. In some embodiments, the ontology service 120 identifies the plurality of procedural events by extracting event indicators from docket entry records, filing metadata, calendar records, court orders, scheduling notices, and captioned document sections in the plurality of legal documents, a combination thereof and the like.

In some embodiments, the ontology service 120 is configured to determine, for each procedural event, an event time value and an event type value. In some embodiments, determining the event time value includes extracting a date value, a time value, and a date range value from structured fields in the normalized records, extracting a date value from text segments that include filing stamps and docket text lines, and normalizing the extracted date value into a standardized date representation, a combination thereof and the like. In some embodiments, determining the event type value includes mapping docket entry descriptions, document type labels, calendar event labels, and rule-based keywords to an event type vocabulary maintained by the ontology service 120, a combination thereof and the like.

In some embodiments, the ontology service 120 is configured to assign stage labels to the procedural events by applying ontology rule tables that map event types and event ordering to procedural stages. In some embodiments, assigning stage labels includes ordering the plurality of procedural events by the event time values, identifying stage-transition conditions defined by the ontology rule tables, and labeling each procedural event with a stage label selected from a stage label set that includes pre-filing stage, filing stage, pleading stage, discovery stage, dispositive motion stage, pretrial stage, trial stage, post-trial stage, appeal stage, enforcement stage, a combination thereof and the like. In some embodiments, the ontology service 120 is configured to associate each procedural event with one and more canonical entities by linking a court identifier, a judicial-officer identifier, a party identifier, and a claim identifier to the procedural event using canonical entity identifiers, a combination thereof and the like.

In some embodiments, the timeline representation is an ordered record set in which each record corresponds to a procedural event and includes an event identifier, an event time value, an event type value, a stage label, and one and more canonical entity identifiers associated with the procedural event, a combination thereof and the like. In some embodiments, the ontology service 120 is configured to record provenance links in the internal repository 145 for each procedural event record by associating the procedural event record with an identifier of at least one normalized record from which the procedural event was identified and with a record-level cryptographic digest value computed over record contents referenced by a batch manifest, a combination thereof and the like.

In some embodiments, the ontology service 120 is configured to store the timeline representation in the internal repository 145. In some embodiments, the timeline representation is stored with lineage linked to the normalized intake schema and the plurality of batches. In some embodiments, the ontology service 120 is configured to associate the timeline representation with a matter identifier.

In some embodiments, the derived features include exposure categories, damages archetypes, fee-shifting eligibility, venue attributes, panel-assignment attributes, limitation-period checkpoints, posture-at-filing indicators, judge-profile attributes, a combination thereof and the like.

In some embodiments, outputs of the ontology service 120 are stored in the internal repository 145 with lineage to the normalized intake schema.

In some embodiments, the outputs include an ontology-aligned dataset linking canonical entities to ontology classes and relations, a feature map that associates calculator inputs to aligned canonical entities and derived features, the timeline representation of procedural events with stage labels, where each procedural event includes an event time value, an event type value, and a stage label assigned by applying ontology rule tables, a registry of provenance links that reference batch manifests and record-level cryptographic digest values computed over record contents, a combination thereof and the like.

In some embodiments, the matter-entity model 122 is trained based on annotated pleadings, court dockets, judicial biographies, historical rulings, structured party lists, the ontology-aligned dataset, entries in the ontology-aligned dataset, a combination thereof and the like. In some embodiments, the training updates parameters of the matter-entity model 122 by iteratively comparing predicted text-span labels and predicted relationship records to annotated labels and annotated relationships and adjusting the parameters to reduce a loss measure, thereby improving extraction of entity spans and relations for legal vocabulary, citation formats, caption styles, and signature blocks.

In some embodiments, the ontology service 120 is configured to perform deterministic extraction based on rule libraries maintained by the ontology service 120, ontology dictionaries, jurisdictional registries, citation grammars, schema validators, and jurisdictional mapping tables that map source-specific labels to standardized identifiers, a combination thereof and the like.

In some embodiments, deterministic extraction includes mapping structured fields to candidate entities using field-to-type maps and hard constraints; parsing names, captions, and statute citations using grammar-driven tokenizers and regular-expression templates; resolving references using court and judge registries with jurisdictional mapping tables; normalizing values through case folding, diacritic handling, abbreviation expansion, and canonical code sets; deduplicating using exact digest values and phonetic hashes with source ranking tie-break rules; disambiguating using rule-based scoring that consults venue, temporal proximity, role constraints, and caption structure, a combination thereof and the like; validating extracted attributes against ontology rule tables; and emitting provenance that links each promoted canonical entity to batch manifests and record-level digest values, a combination thereof and the like.

In some embodiments, the ontology service 120 is configured to perform deterministic extraction as defined herein, to align the resulting canonical entities to the jurisdiction-aware legal ontology, to derive calculator-ready features, and to persist lineage in the context & governance service 130, a combination thereof and the like. In some embodiments, deterministic extraction is performed in lieu of the matter-entity model 122.

In some embodiments, a context & governance service 130 is configured to assemble and to persist a matter context record that downstream components utilize for calculator rendering, feature binding, calibrated prediction, sensitivity analysis, collaboration workflows, a combination thereof and the like.

For example, the matter context record includes jurisdiction, court identifiers, judicial-officer identifiers, claim types, procedural stage labels, timeline representations, exposure categories, damages archetypes, and fee-shifting eligibility, a combination thereof and the like.

The context & governance service 130 is configured to store the ontology-aligned dataset, to maintain a feature map that links calculator inputs to canonical entities and derived features, and to maintain a source ledger that records source position indicators, event notification messages, source connector commits, a combination thereof and the like.

The context & governance service 130 is further configured to write audit blocks that hash normalized batches, record authorization decisions, and capture before-and-after values for contested merges.

In some embodiments, the context & governance service 130 is configured to assemble the matter context record by associating a matter identifier with batches persisted in the context & governance service 130 by the data ingestion pipeline 110, where each batch includes a batch manifest and normalized records that conform to the normalized intake schema, a combination thereof and the like.

In some embodiments, the context & governance service 130 is further configured to associate the matter identifier with outputs of the ontology service 120 stored in the context & governance service 130, where the outputs include canonical entities, an ontology-aligned dataset linking canonical entities to ontology classes and relations, derived features, the timeline representation of procedural events with stage labels, and provenance links, a combination thereof and the like.

In some embodiments, the context & governance service 130 is further configured to incorporate governance artifacts into the matter context record by associating the matter identifier with the source ledger and audit blocks, and by linking each batch manifest to at least one audit block and at least one provenance link that references record-level cryptographic digest values computed over record contents, a combination thereof and the like.

In some embodiments, the context & governance service 130 is configured to enforce data-handling constraints for stored artifacts.

In some embodiments, the enforcement includes evaluation of data-minimization profiles, redaction of restricted fields, substitution of pseudonymous identifiers for personally identifiable information, application of retention-class labels, and control of access through attribute-based rules, a combination thereof and the like.

In some embodiments, the context & governance service 130 is further configured to safeguard credentials and encryption materials through key-wrapping encryption in which a data-encryption key encrypts payload data and a key-encryption key encrypts the data-encryption key, where the key-encryption key is protected by a hardware security module, while issuing time-limited connection handles that reference stored credentials without revealing stored credentials to the data ingestion pipeline 110, a combination thereof and the like.

In some embodiments, live synchronization is supported as a deployment choice. For example, the data ingestion pipeline 110 is configured to registers event notification subscriptions and polling schedules, process change notifications through normalization, the ontology service 120 is configured to refresh canonical entities and derived features, and the context & governance service 130 is configured to append an additional audit block while advancing the matter context record with version continuity, a combination thereof and the like.

In some embodiments, a calculator selection service 140 is configured to present a calculator interface that enables selection of a pre-defined calculator template and creation of a new calculator definition based on the matter context record.

In some embodiments, the calculator selection service 140 is configured to obtain, from the matter context record, canonical entities, derived features, the timeline representation of procedural events with stage labels, a feature map, a combination thereof and the like.

In some embodiments, the feature map associates calculator inputs to aligned canonical entities, derived features, a combination thereof and the like.

In some embodiments, the calculator selection service 140 is configured to use the obtained canonical entities, derived features, and the timeline representation to constrain available calculator templates and to initialize default values for a calculator definition, a combination thereof and the like.

In some embodiments, the calculator selection service 140 is configured to retrieve a calculator template from a calculator template repository. In some embodiments, the calculator template repository is the internal repository 145.

In some embodiments, each calculator template includes a calculator definition that specifies input field names, input field types, permitted value ranges, required-field constraints, inter-field consistency rules, computational relationships, and presentation bindings for output visualization, a combination thereof and the like.

In some embodiments, the calculator selection service 140 is configured to validate template eligibility by comparing template eligibility data to information obtained from the matter context record, where the information includes jurisdiction-aware identifiers represented by canonical entities, procedural stage labels represented in the timeline representation, derived features, a combination thereof and the like.

In some embodiments, the calculator selection service 140 is configured to instantiate a selected calculator template into a matter-specific calculator definition. In some embodiments, instantiation includes linking input fields of the calculator definition to canonical entities and derived features and recorded in the matter context record, initializing input fields using values represented in the matter context record and the timeline representation, and recording the linkage as part of the feature map, a combination thereof and the like.

In some embodiments, the calculator selection service 140 is configured to persist the instantiated calculator definition in the context & governance service 130 with lineage to the matter context record and to the calculator template repository entry from which the calculator definition was instantiated, a combination thereof and the like.

In some embodiments, a calculator generation engine 150 is configured to generate a calculator definition responsive to a user request that describes a calculator objective.

In some embodiments, the calculator generation engine 150 is configured to obtain, from the matter context record, the canonical entities, the derived features, the timeline representation of procedural events with stage labels, and the ontology-aligned dataset linking canonical entities to ontology classes and relations, a combination thereof and the like.

In some embodiments, the calculator generation engine 150 is configured to align terminology in the user request to canonical entities and ontology classes represented in the ontology-aligned dataset, and to generate a calculator definition that specifies input fields, permitted value ranges, required-field constraints, inter-field consistency rules, and computational relationships, a combination thereof and the like. In some embodiments, the aligning includes parsing the user request to identify terminology items and, for each terminology item, querying the ontology-aligned dataset for candidate matches among canonical entity labels, canonical entity aliases, ontology class labels, and ontology class aliases, a combination thereof and the like. In some embodiments, the calculator generation engine 150 computes a match score for each candidate match by applying string similarity and token overlap measures and by applying an embedding similarity measure between the terminology item and the candidate match label, a combination thereof and the like. In some embodiments, the calculator generation engine 150 filters candidate matches using matter-scoped attributes represented in the matter context record, including jurisdiction identifiers, court identifiers, judicial-officer identifiers, and procedural stage labels, a combination thereof and the like, and selects an aligned canonical entity identifier and an aligned ontology class identifier responsive to the match score satisfying a threshold and the candidate match satisfying the filtering. In some embodiments, the calculator generation engine 150 records the aligning by storing linkages that associate at least a subset of the input fields to canonical entities and derived features in the feature map and by storing class linkages that associate at least a subset of the input fields to ontology classes in the calculator definition, a combination thereof and the like.

In some embodiments, when no candidate match satisfies the threshold after the filtering, the calculator generation engine 150 records an unresolved-reference indicator for the terminology item and causes presentation of a disambiguation control that lists a subset of candidate matches for selection through the calculator interface. In some embodiments, responsive to receiving a selection, the calculator generation engine 150 stores an updated linkage in the feature map that associates the terminology item with the selected canonical entity identifier and stores an updated class linkage in the calculator definition that associates the terminology item with the selected ontology class identifier, a combination thereof and the like.

In some embodiments, the calculator generation engine 150 is configured to associate at least a subset of the input fields to canonical entities and derived features by recording linkages into the feature map maintained by the context & governance service 130, a combination thereof and the like.

In some embodiments, a language-to-calculator model 152 receives the user request together with information obtained from the matter context record, where the information includes canonical entities, derived features, procedural stage labels, and ontology class relations represented in the ontology-aligned dataset, a combination thereof and the like, and outputs a structured calculator representation that enumerates candidate input fields, candidate computational relationships, and candidate constraints.

In some embodiments, the language-to-calculator model 152 is trained based on annotated calculator templates, annotated legal analyses, jurisdiction-aware rule summaries, curated examples of financial and legal computations, and calculator definitions previously stored in the context & governance service 130, a combination thereof and the like. In some embodiments, the training data includes, for each training example, a user request that describes a calculator objective and a corresponding target structured calculator representation that enumerates candidate input fields, candidate computational relationships, and candidate constraints, where the target structured calculator representation is derived from a calculator definition associated with the training example.

In some embodiments, a calculator interface is implemented as a deployable application instance generated by a language model. In some embodiments, the language model receives a user request that specifies a calculator objective together with structured legal matter data (including canonical entities, derived features, and jurisdiction-aware attributes) and outputs application code that implements an interactive calculator interface for the legal matter. In some embodiments, the output application code includes user-interface components, a field-binding layer that connects calculator inputs to model-facing feature construction, and output visualization components that present prediction outputs derived from calibrated prediction outputs, a combination thereof and the like.

In some embodiments, the calculator generation engine 150 is configured to reconcile the structured calculator representation into a calculator definition. In some embodiments, the reconciling includes resolving field names to consistent labels, converting constraint expressions into the format used by the calculator definition, verifying that computational relationships reference defined input fields, linking at least a subset of input fields to canonical entities and derived features, a combination thereof and the like.

In some embodiments, a calculator validation service 155 is configured to validate a calculator definition prior to use.

In some embodiments, validation includes verifying that each input field satisfies type constraints and permitted value ranges, verifying that each required field is present, verifying that inter-field consistency rules are satisfiable under the permitted value ranges, verifying that computational relationships do not contain cycles among dependent fields, verifying that constraint expressions reference defined fields, verifying that jurisdiction-aware eligibility reflected in the matter context record is consistent with template eligibility data and constraint rules in the calculator definition, a combination thereof and the like.

In some embodiments, the calculator validation service 155 is configured to generate validation results that identify invalid fields, conflicting constraints, unresolved references, and cycles among dependent fields, a combination thereof and the like, and to persist the validation results in the context & governance service 130 with lineage to the calculator definition.

In some embodiments, the output application code includes a declarative representation (e.g., a schema or manifest) that enumerates input fields, constraints, computational relationships, and output visualization bindings, and further includes executable user interface instructions that render the interactive calculator interface from the declarative representation. In some embodiments, the output application code is generated as a web application that includes client-side logic for interactive updates and server-side endpoints for prediction evaluation and governance logging, a combination thereof and the like.

In some embodiments, prior to deployment or execution, a validation pipeline is applied to generated application code and/or to a generated calculator definition. In some embodiments, the validation pipeline includes static analysis checks that detect unsafe operations and unauthorized resource access, type checking that verifies conformance of input-field values and intermediate values to declared types, linting that enforces style and structural rules for maintainability, and an accessibility audit that verifies that generated user interface elements include accessibility attributes and a usable focus order for keyboard navigation, a combination thereof and the like.

In some embodiments, the validation pipeline further includes calculator-specific checks that verify that constraint expressions reference defined input fields, that required-field constraints and permitted value ranges are satisfiable, and that computational relationships do not form dependency cycles. In some embodiments, responsive to detecting a validation failure, the system blocks deployment and records a validation report that identifies a failing module, a failing rule, and a remediation suggestion. In some embodiments, remediation includes regenerating at least a portion of the application code under a modified prompt that includes the validation report and a constraint that prohibits the failing construct, a combination thereof and the like.

In some embodiments, the deployment pipeline compiles and packages the generated application code into an executable bundle. In some embodiments, packaging includes bundling client-side assets, generating a versioned artifact identifier, and producing a deployment manifest that identifies the calculator definition or schema used to generate the bundle, a model identifier used for prediction evaluation, and governance metadata required for controlled release, a combination thereof and the like. In some embodiments, the executable bundle is deployed to a content distribution network (CDN) and is served to user devices as a versioned application instance associated with a matter identifier.

In some embodiments, the calculator definition is stored in the internal repository 145 as a versioned artifact. In some embodiments, the stored calculator definition is associated with an approval status. In some embodiments, the approval status includes draft status, review status, approved status, and retired status, a combination thereof and the like. In some embodiments, provenance is recorded in the internal repository 145 that links the calculator definition to the matter context record, to a calculator template repository entry when applicable, to validation results produced by the calculator validation service 155, a combination thereof and the like.

In some embodiments, a calculator rendering service 160 is configured to render an interactive calculator interface from a validated calculator definition.

In some embodiments, rendering includes presenting input fields, presenting constraint feedback, updating dependent fields responsive to changes in upstream fields, and presenting output visualization bindings defined by the calculator definition, a combination thereof and the like.

In some embodiments, the calculator rendering service 160 is configured to obtain the calculator definition and associated linkages from the context & governance service 130 and to present the calculator interface together with explanatory labels derived from the ontology-aligned dataset produced by the ontology service 120, a combination thereof and the like.

In some embodiments, a calculator interface generation engine 165 is configured to generate executable user interface instructions from a validated calculator definition.

In some embodiments, generation includes producing a user interface layout that places input fields and output visualization regions according to the calculator definition, encoding validation constraints as interactive feedback rules, and encoding computational relationships as evaluation steps executed responsive to user input, a combination thereof and the like.

In some embodiments, the calculator interface generation engine 165 is configured to verify the executable user interface instructions by applying rule-based checks that confirm required fields are present, confirm constraint feedback rules correspond to constraint expressions in the calculator definition, confirm computational relationships reference defined fields, and confirm the executable user interface instructions correspond to the validated calculator definition, a combination thereof and the like.

In some embodiments, the executable user interface instructions and associated verification results are stored in the context & governance service 130 with lineage to the calculator definition, a combination thereof and the like.

In some embodiments, a calculator rendering service 160 is configured to render an interactive calculator interface for a validated calculator definition.

In some embodiments, the calculator rendering service 160 is configured to obtain, from the context & governance service 130, the validated calculator definition, an approval status associated with the validated calculator definition, and linkages recorded in the feature map that associate calculator inputs to canonical entities and derived features produced by the ontology service 120, a combination thereof and the like.

In some embodiments, the calculator rendering service 160 is configured to render the interactive calculator interface by selecting an initial set of input fields and output visualization bindings specified by the validated calculator definition, and by populating at least a subset of the input fields using values represented in the matter context record and the timeline representation of procedural events with stage labels, a combination thereof and the like.

In some embodiments, the interactive calculator interface is rendered for display on a user device (e.g., a client device executing a web browser or native application) using executable user interface instructions generated from the validated calculator definition. In some embodiments, the interactive calculator interface is rendered for presentation on a user device, where rendering is performed locally on the user device using executable user interface instructions, is performed remotely by a rendering service with the resulting interface streamed to the user device, or a combination thereof.

In some embodiments, the calculator rendering service 160 is configured to present input fields within the interactive calculator interface according to input field types specified by the validated calculator definition. In some embodiments, presentation includes displaying numeric entry controls, selection controls, toggle controls, and range controls, a combination thereof and the like, where each control is associated with permitted value ranges, required-field constraints, and inter-field consistency rules specified by the validated calculator definition.

In some embodiments, the calculator rendering service 160 is configured to present constraint feedback by evaluating the required-field constraints and inter-field consistency rules against current user-provided values and current initialized values, and by displaying a constraint violation indicator and an explanatory message responsive to a detected constraint violation, a combination thereof and the like.

In some embodiments, the calculator rendering service 160 is configured to update dependent fields responsive to changes in upstream fields according to computational relationships specified by the validated calculator definition.

In some embodiments, update behavior includes identifying a set of dependent fields referenced by a computational relationship, recomputing values for the set of dependent fields using current input values and derived features linked through the feature map, propagating updated values through additional computational relationships that reference the updated values, a combination thereof and the like.

In some embodiments, the calculator rendering service 160 is configured to maintain an evaluation order that prevents cycles among dependent fields by ordering computational relationships according to dependencies among referenced fields, and by suspending evaluation of a computational relationship that would reintroduce a previously evaluated field within a single update operation, a combination thereof and the like.

In some embodiments, the validated calculator definition specifies computational relationships that define dependencies among fields, where a first field is treated as an upstream field when the first field is referenced by a computational relationship, and a second field is treated as a dependent field when the second field is assigned by the computational relationship, a combination thereof and the like.

In some embodiments, the calculator rendering service 160 is configured to apply the computational relationships in an order determined from the dependencies among fields specified by the computational relationships, where the order prevents a cycle among dependent fields identified by validation performed by the calculator validation service 155, a combination thereof and the like.

In some embodiments, the calculator rendering service 160 is configured to present output visualization bindings specified by the validated calculator definition. In some embodiments, presentation includes displaying an output panel that includes numeric results, percentile bands, timeline projections, decision-tree visualizations, case-map visualizations, and sensitivity summaries, a combination thereof and the like, where each displayed output is linked to one or more input fields and one or more derived features through the feature map.

In some embodiments, the calculator rendering service 160 is configured to refresh the output panel responsive to a change in an input field by re-evaluating computational relationships and updating output values referenced by the output visualization bindings, a combination thereof and the like.

In some embodiments, the calculator rendering service 160 is configured to persist an interaction record in the internal repository 145 that captures user-provided values, initialized values, and output values generated during an interaction session, a combination thereof and the like.

In some embodiments, the interaction record includes a reference to the validated calculator definition, a reference to the matter context record, a reference to the approval status, and provenance links that reference batches and record-level cryptographic digest values computed over record contents, a combination thereof and the like. In some embodiments, the interaction record is stored in the internal repository 145 as a versioned artifact associated with the matter context record.

In some embodiments, the calculator rendering service 160 is configured to render the interactive calculator interface using the executable user interface instructions stored in the context & governance service 130 together with verification results produced by the calculator interface generation engine 165, a combination thereof and the like.

In some embodiments, the calculator interface generation engine 165 is configured to generate executable user interface instructions from the validated calculator definition, verify the executable user interface instructions, a combination thereof and the like.

In some embodiments, the calculator interface generation engine 165 is configured to generate one or more prediction outputs for display within the interactive calculator interface rendered by the calculator rendering service 160, where the prediction outputs are generated using a validated calculator definition persisted by the context & governance service 130 and information stored in the matter context record, a combination thereof and the like.

In some embodiments, the calculator interface generation engine 165 is configured to obtain, from the context & governance service 130, the validated calculator definition, the feature map, canonical entities produced by the ontology service 120, derived features produced by the ontology service 120, and the timeline representation of procedural events with stage labels, a combination thereof and the like.

In some embodiments, a feature binding service 170 is configured to construct a model feature representation.

In some embodiments, the model feature representation includes a structured set of feature values derived from user-provided values received through the interactive calculator interface, canonical entities, derived features, and the timeline representation stored in the matter context record, as linked by the feature map, a combination thereof and the like.

In some embodiments, the model feature representation is constructed by applying the feature map to user-provided values received through the interactive calculator interface and to information stored in the matter context record, a combination thereof and the like. In some embodiments, the feature binding service 170 is configured to identify calculator input fields referenced by the validated calculator definition, to obtain current values for the calculator input fields from the calculator rendering service 160, and to associate at least a subset of the calculator input fields to canonical entities and derived features using linkages recorded in the feature map, a combination thereof and the like. In some embodiments, the feature binding service 170 is further configured to normalize the current values using field types and permitted value ranges specified by the validated calculator definition and to incorporate selected derived features and selected timeline attributes referenced by the validated calculator definition, a combination thereof and the like.

In some embodiments, a predictive model receives the model feature representation produced by the feature binding service 170 and outputs one or more model output corresponding to a matter outcome. In some embodiments, the model output includes a predicted likelihood value, a predicted expected value, a predicted range of values, a predicted time-to-event value, a combination thereof and the like. In some embodiments, the predictive model is trained based on historical matters represented using canonical entities, derived features, procedural stage labels, outcome labels, a combination thereof and the like, where training includes updating parameters of the predictive model to reduce an error measure between predicted results and observed outcomes represented in training data.

In some embodiments, a calibration service 175 is configured to calibrate the model output. In some embodiments, the calibration service 175 receives the model output together with a matter identifier that enables access to a matter context record used for calibration cohort selection.

In some embodiments, the calibration service 175 is configured to obtain calibration inputs that identify a calibration cohort using jurisdiction identifiers, court identifiers, judicial-officer identifiers, claim types, and procedural stage labels represented in the matter context record, a combination thereof and the like.

In some embodiments, the calibration service 175 is configured to select, from a plurality of stored calibration mappings, a cohort-matched calibration mapping based on the calibration cohort and to apply the selected calibration mapping to the model output to generate a calibrated prediction output. In some embodiments, selecting the cohort-matched calibration mapping includes performing a key-based lookup using the calibration inputs and applying a fallback rule that selects a broader cohort mapping responsive to the calibration cohort failing a minimum support threshold, a combination thereof and the like.

In some embodiments, calibration mappings are generated by fitting a calibration model using historical matters for which observed outcomes are available. In some embodiments, historical matters are partitioned into one or more calibration cohorts based on one or more of jurisdiction identifiers, court identifiers, judicial-officer identifiers, claim types, and procedural stage labels, and a cohort-specific calibration mapping is generated for each calibration cohort. In some embodiments, fitting includes obtaining, for each historical matter in a calibration cohort, a model output produced by a predictive model and an observed outcome label, and optimizing parameters of the calibration mapping to reduce a calibration loss that measures deviation between calibrated prediction outputs and observed outcome frequencies within the calibration cohort, a combination thereof and the like.

In some embodiments, a calibration mapping is represented as a monotonic transform or a bounded lookup structure that maps a model output to a calibrated prediction output. In some embodiments, the calibration mapping is constrained to be monotonic with respect to the model output and is regularized to reduce overfitting for cohorts having limited sample sizes.

In some embodiments, generation of a calibration mapping includes evaluating calibration quality using held-out validation matters, where evaluation includes computing a calibration error metric across probability bands and computing a coverage measure for the calibration cohort. In some embodiments, responsive to satisfying one or more acceptance thresholds, the system persists the calibration mapping as a versioned calibration artifact in the internal repository 145, where the versioned calibration artifact includes a cohort definition, a mapping identifier, mapping parameters, and calibration metrics, and is associated with an approval status history, a combination thereof and the like.

In some embodiments, the calibration service 175 is configured to retrieve an approved versioned calibration artifact from the internal repository 145 and to generate the calibrated prediction output by applying the mapping parameters of the approved versioned calibration artifact to the model output.

In some embodiments, the calibrated prediction output includes a calibrated likelihood value together with a coverage indicator that characterizes reliability of the calibrated likelihood value for the calibration cohort, a combination thereof and the like.

In some embodiments, the calibration service 175 persists calibration provenance in the internal repository 145. In some embodiments, calibration provenance includes associating the calibrated prediction output with an identifier of the predictive model, an identifier of the calibration cohort, an identifier and version of the applied calibration mapping artifact, and provenance links that reference batch manifests and record-level cryptographic digest values computed over record contents, a combination thereof and the like.

In some embodiments, an explanation service 180 is configured to generate explanatory information for a prediction output displayed within the interactive calculator interface.

In some embodiments, the explanation service 180 is configured to identify, from the model feature representation, a set of contributing factors and corresponding contribution magnitudes and to map the contributing factors back to calculator input fields, canonical entities, derived features, and procedural stage labels using the feature map and the ontology-aligned dataset, a combination thereof and the like.

In some embodiments, the explanation service 180 is configured to produce an explanation package that includes factor labels, contribution magnitudes, and provenance links that reference the matter context record and the validated calculator definition, a combination thereof and the like.

In some embodiments, the calculator interface generation engine 165 is configured to update a prediction output responsive to an input change within the interactive calculator interface. In some embodiments, the calculator interface generation engine 165 is configured to receive an input-change indication from the calculator rendering service 160, to obtain updated input values for at least a subset of input fields, to provide the updated input values to the feature binding service 170 to update the model feature representation, to provide the updated model feature representation to the predictive model to obtain a model output, to provide the model output to the calibration service 175 to obtain a calibrated prediction output, and to provide the calibrated prediction output to the calculator rendering service 160 for presentation as the prediction output according to output visualization bindings specified by the validated calculator definition. In some embodiments, the calculator interface generation engine 165 is further configured to cause the explanation service 180 to produce an explanation package associated with the prediction output.

In some embodiments, the explanation service 180 is configured to store a prediction record in the internal repository 145. In some embodiments, storing the prediction record includes associating with the matter context record, the validated calculator definition, a combination thereof and the like. In some embodiments, the prediction record includes input values utilized to construct the model feature representation, the model feature representation, the model output (such as the model output by the predictive model), the calibrated prediction output produced by the calibration service 175, and the explanation package produced by the explanation service 180, a combination thereof and the like. In some embodiments, the prediction record includes provenance links that reference batch manifests and record-level cryptographic digest values computed over record contents and an approval status associated with the validated calculator definition, a combination thereof and the like.

In some embodiments, a scenario analysis service 185 is configured to generate a plurality of scenario-specific prediction outputs for display within the interactive calculator interface rendered by the calculator rendering service 160.

In some embodiments, each scenario-specific prediction output among the plurality of scenario-specific prediction outputs is generated using the validated calculator definition, information stored in the matter context record, a combination thereof and the like.

In some embodiments, the scenario analysis service 185 is configured to obtain, from the context & governance service 130, the validated calculator definition, the feature map, canonical entities, derived features, and the timeline representation of procedural events with stage labels, a combination thereof and the like.

In some embodiments, the scenario analysis service 185 is configured to define a scenario set that includes a baseline scenario and a plurality of alternative scenarios.

In some embodiments, the baseline scenario includes current user-provided values for input fields displayed in the interactive calculator interface, together with initialized values obtained from the matter context record. In some embodiments, each alternative scenario includes a modified set of input values obtained by applying a scenario rule to at least one input field, where the scenario rule specifies a perturbation, a substitution, and a constraint that bounds the modified set of input values, a combination thereof and the like. In some embodiments, the scenario analysis service 185 is configured to store the scenario set in the internal repository 145 with lineage to the validated calculator definition and the matter context record.

In some embodiments, the scenario analysis service 185 is configured to identify scenario dimensions from the validated calculator definition and the feature map.

In some embodiments, a scenario dimension corresponds to an input field linked to a derived feature, an input field linked to a canonical entity, and an input field that influences a computational relationship, a combination thereof and the like.

In some embodiments, the scenario analysis service 185 is configured to select scenario dimensions based on sensitivity of a prediction output to the scenario dimensions, where sensitivity is determined by comparing a baseline prediction output to one or more alternative prediction outputs generated using perturbed input values, a combination thereof and the like.

In some embodiments, the scenario analysis service 185 is configured to generate scenario-specific model feature representations for the plurality of scenarios by applying the feature map to the scenario-specific input values and to information stored in the matter context record.

In some embodiments, the scenario analysis service 185 is configured to provide a scenario-specific model feature representation to the predictive model to obtain the model output for the scenario.

In some embodiments, the scenario analysis service 185 is configured to provide the model output to a calibration service 175 to obtain a calibrated prediction output for the scenario. In some embodiments, the scenario analysis service 185 is configured to generate a scenario-specific prediction output for presentation by formatting the calibrated prediction output according to output visualization bindings specified by the validated calculator definition, a combination thereof and the like.

In some embodiments, the scenario analysis service 185 is configured to generate a comparative scenario view for presentation within the interactive calculator interface. In some embodiments, the comparative scenario view includes a baseline prediction output and a plurality of alternative prediction outputs, together with a display of scenario-specific input values that differ from the baseline scenario, a combination thereof and the like. In some embodiments, the comparative scenario view includes a difference value between a baseline calibrated prediction output and an alternative calibrated prediction output, a percent change value, and a ranked list of scenario dimensions according to sensitivity, a combination thereof and the like.

In some embodiments, the scenario analysis service 185 is configured to enforce scenario constraints during scenario generation. In some embodiments, enforcement includes verifying permitted value ranges and required-field constraints specified by the validated calculator definition, verifying inter-field consistency rules specified by the validated calculator definition, and verifying jurisdiction-aware eligibility reflected in the matter context record, a combination thereof and the like.

In some embodiments, the scenario analysis service 185 is configured to exclude an alternative scenario responsive to a detected constraint violation and to generate a constraint explanation that identifies the violated constraint and the input field associated with the violated constraint, a combination thereof and the like.

In some embodiments, the scenario analysis service 185 is configured to store a scenario analysis record in the internal repository 145. In some embodiments, storing the scenario analysis records includes associating with the matter context record, the validated calculator definition, a combination thereof and the like. In some embodiments, the scenario analysis record includes the scenario set, scenario-specific input values, scenario-specific model feature representations, scenario-specific model outputs, scenario-specific calibrated prediction outputs, and scenario-specific prediction outputs, a combination thereof and the like. In some embodiments, the scenario analysis record includes provenance links that reference batch manifests and record-level cryptographic digest values computed over record contents and an approval status associated with the validated calculator definition, a combination thereof and the like.

In some embodiments, a collaboration and review service 190 is configured to manage collaborative review of artifacts, where the artifacts include validated calculator definitions, approval statuses associated with the validated calculator definitions, prediction records, and scenario analysis records, a combination thereof and the like.

In some embodiments, the collaboration and review service 190 is configured to obtain the matter context record, a feature map, provenance links, audit blocks, and a source ledger, a combination thereof and the like, and to use the obtained information to support review, defensibility, and access control for collaborative workflows.

In some embodiments, the collaboration and review service 190 is configured to present a collaboration interface that enables creation of review comments associated with an artifact.

In some embodiments, each review comment includes comment text and an artifact reference that identifies a target portion of a validated calculator definition, a prediction record, a scenario analysis record, and a portion of the matter context record, a combination thereof and the like. In some embodiments, the collaboration and review service 190 is configured to store review comments in the internal repository 145 with lineage to the referenced artifact and with provenance links that reference batch manifests and record-level cryptographic digest values computed over record contents, a combination thereof and the like.

In some embodiments, the collaboration and review service 190 is configured to manage assignment of review tasks to reviewers. In some embodiments, each review task includes a reviewer identifier, an artifact reference, a review status indicator, and a review deadline, a combination thereof and the like. In some embodiments, the collaboration and review service 190 is configured to store review tasks in the internal repository 145 and to associate each review task with an approval status associated with a validated calculator definition, a combination thereof and the like.

In some embodiments, the collaboration and review service 190 is configured to manage transitions among approval statuses for a calculator definition stored as a versioned artifact in the context & governance service 130. In some embodiments, the transitions include transition from draft status to review status, transition from review status to approved status, and transition from approved status to retired status, a combination thereof and the like.

In some embodiments, the collaboration and review service 190 is configured to enforce transition rules by verifying that required reviewers associated with review tasks have provided review comments, verifying that validation results produced by the calculator validation service 155 indicate no unresolved violations, and verifying that access scope attributes recorded by the context & governance service 130 authorize an approving principal to approve the calculator definition, a combination thereof and the like.

In some embodiments, the collaboration and review service 190 is configured to enable real-time collaboration on a shared calculator instance rendered by the calculator rendering service 160. In some embodiments, a plurality of user devices concurrently edit values of input fields, scenario definitions, and annotations associated with a validated calculator definition, and the collaboration and review service 190 replicates the edits such that each user device maintains a consistent view of a shared calculator state, a combination thereof and the like.

In some embodiments, the collaboration and review service 190 is configured to represent edits as operations applied to a conflict-free replicated data type (CRDT) and to merge concurrent operations from multiple user devices using deterministic merge rules that preserve causal ordering of operations. In some embodiments, preserving causal ordering includes associating operations with causality indicators, including vector clock values, logical timestamps, resolving concurrent edits to a same calculator field using a deterministic tie-break rule, a combination thereof and the like. In some embodiments, responsive to a merged shared calculator state, the calculator rendering service 160 updates the interactive calculator interface and triggers regeneration of dependent fields and prediction outputs as described herein.

In some embodiments, the collaboration and review service 190 is configured to generate a review provenance package for an artifact.

In some embodiments, the review provenance package includes an artifact identifier, a version identifier, an approval status history, reviewer identifiers, review comments, review task status indicators, and provenance links that reference batch manifests, record-level cryptographic digest values computed over record contents, and audit blocks, a combination thereof and the like.

In some embodiments, the collaboration and review service 190 is configured to store the provenance package in the internal repository 145 with lineage to the artifact identifier.

In some embodiments, the collaboration and review service 190 is configured to support controlled sharing of an artifact to a recipient principal. In some embodiments, controlled sharing includes selecting an access scope attribute set for the recipient principal, associating the access scope attribute set with the artifact identifier in the context & governance service 130, and limiting access to the artifact identifier according to attribute-based rules, a combination thereof and the like. In some embodiments, the collaboration and review service 190 is configured to generate a shared-view presentation that redacts restricted fields in accordance with data-handling constraints. In some embodiments, the shared-view presentation includes a subset of provenance links to support the prediction output.

In some embodiments, the collaboration and review service 190 enables concurrent editing of a shared calculator instance and merges concurrent edits using conflict-free replicated data types (CRDTs) with deterministic merge rules that preserve causal ordering, thereby triggering regeneration of dependent fields and prediction outputs.

In some embodiments, a report generation service 195 is configured to generate a report package that summarizes artifacts stored in the internal repository 145 for a matter, where the artifacts include a matter context record, a validated calculator definition, prediction records, scenario analysis records, review comments, approval status history, a combination thereof and the like.

In some embodiments, the report generation service 195 is configured to obtain, from the internal repository 145, the matter context record, the validated calculator definition, the feature map, the ontology-aligned dataset linking canonical entities to ontology classes and relations, derived features, the timeline representation of procedural events with stage labels, provenance links, audit blocks, and a source ledger, a combination thereof and the like.

In some embodiments, the report generation service 195 is configured to construct a report outline that enumerates report sections corresponding to the validated calculator definition and associated prediction outputs. In some embodiments, the report sections include a matter context section that identifies canonical entities and derived features utilized by the validated calculator definition, a calculator definition section that identifies input fields, permitted value ranges, required-field constraints, inter-field consistency rules, computational relationships, and output visualization bindings, a combination thereof and the like. In some embodiments, the report sections further include a prediction section that presents prediction outputs together with a mapping from the prediction outputs to calculator input fields and derived features using the feature map, and a scenario section that presents comparative scenario views produced by the scenario analysis service 185, a combination thereof and the like.

In some embodiments, the report generation service 195 is configured to populate the matter context section by selecting a subset of canonical entities, derived features, and procedural stage labels represented in the timeline representation, a combination thereof and the like. In some embodiments, the selected information is formatted using labels derived from the ontology-aligned dataset, a combination thereof and the like.

In some embodiments, the report generation service 195 is configured to populate the calculator definition section by enumerating calculator input fields and corresponding constraints, and by enumerating computational relationships and output visualization bindings as stored in the validated calculator definition, a combination thereof and the like.

In some embodiments, the report generation service 195 is configured to populate the prediction section by selecting, from one or more prediction records, user-provided values utilized to construct model feature representations, model outputs produced by the predictive model, calibrated prediction outputs produced by the calibration service 175, prediction outputs presented through the interactive calculator interface, and explanation packages produced by the explanation service 180, a combination thereof and the like.

In some embodiments, the report generation service 195 is configured to present a prediction output together with an explanation package that identifies contributing factors and contribution magnitudes mapped to calculator input fields, canonical entities, and derived features through the feature map and the ontology-aligned dataset, a combination thereof and the like.

In some embodiments, the report generation service 195 is configured to populate the scenario section by selecting, from a scenario analysis record, a baseline scenario, alternative scenarios, scenario-specific prediction outputs, and scenario-specific input values that differ from the baseline scenario, a combination thereof and the like.

In some embodiments, the report generation service 195 is configured to present a comparative scenario view that includes baseline prediction outputs and alternative prediction outputs together with scenario constraints and a ranked list of scenario dimensions, a combination thereof and the like.

In some embodiments, the report generation service 195 is configured to generate a provenance section that supports defensibility of the report package. In some embodiments, the provenance section includes approval status history for the validated calculator definition, review comments, review task status indicators persisted by the collaboration and review service 190, provenance links that reference batch manifests and record-level cryptographic digest values computed over record contents, a combination thereof and the like.

In some embodiments, the provenance section includes a lineage summary that associates each prediction record and scenario analysis record to a version identifier of the validated calculator definition and to a version identifier of the matter context record, a combination thereof and the like.

In some embodiments, the report generation service 195 is configured to enforce data-handling constraints during report generation. In some embodiments, enforcement includes applying redaction rules and pseudonymous identifiers, limiting included fields based on access scope attributes associated with a requesting principal, and excluding restricted provenance links according to attribute-based rules, a combination thereof and the like.

In some embodiments, the report generation service 195 is configured to persist the report package in the internal repository 145 as a versioned artifact with lineage to the validated calculator definition, the matter context record, and included prediction records and scenario analysis records, a combination thereof and the like.

In some embodiments, a monitoring and update service 200 is configured to maintain currency of the matter context record stored in the internal repository 145 and to refresh downstream artifacts responsive to detected changes in underlying source systems, a combination thereof and the like.

In some embodiments, the monitoring and update service 200 is configured to obtain an ingestion itinerary that identifies endpoints and source position indicators, and to obtain access scope attributes that authorize change monitoring for declared source systems, a combination thereof and the like. In some embodiments, the ingestion itinerary is retrieved from the internal repository 145.

In some embodiments, the monitoring and update service 200 is configured to receive event notification messages transmitted by a source system responsive to a change and to cause the data ingestion pipeline 110 to perform an additional extraction job using an updated source position indicator, a combination thereof and the like.

In some embodiments, the monitoring and update service 200 is configured to cause the data ingestion pipeline 110 to generate an additional batch that includes a batch manifest and normalized records that conform to the normalized intake schema, and to persist the additional batch in the internal repository 145 as an additional version under the write-once versioning policy, a combination thereof and the like.

In some embodiments, the monitoring and update service 200 is configured to cause the ontology service 120 to refresh canonical entities, the ontology-aligned dataset, derived features, and the timeline representation of procedural events with stage labels responsive to persistence of the additional batch, a combination thereof and the like.

In some embodiments, the monitoring and update service 200 is configured to append additional provenance links, additional audit block, a combination thereof and the like, in the internal repository 145 that references the additional batch manifest and record-level cryptographic digest values computed over record contents, and to update the matter context record to reflect the refreshed canonical entities, refreshed derived features, and refreshed timeline representation, a combination thereof and the like.

In some embodiments, the monitoring and update service 200 is configured to evaluate whether a validated calculator definition is affected by the refreshed matter context record. In some embodiments, evaluation includes comparing canonical entities and derived features referenced by linkages in the feature map to refreshed canonical entities and refreshed derived features, and comparing procedural stage labels referenced by the validated calculator definition to refreshed procedural stage labels represented in the timeline representation, a combination thereof and the like.

In some embodiments, the monitoring and update service 200 is configured to designate an affected calculator definition responsive to detection of a difference that satisfies an update threshold, where the update threshold is determined by a magnitude of change in at least one derived feature and by a change in at least one canonical entity referenced by the calculator definition, a combination thereof and the like.

In some embodiments, responsive to designation of the affected calculator definition, the monitoring and update service 200 is configured to cause the calculator validation service 155 to re-validate the affected calculator definition using refreshed information stored in the matter context record, a combination thereof and the like.

In some embodiments, responsive to successful re-validation, the monitoring and update service 200 is configured to cause the calculator rendering service 160 to refresh the interactive calculator interface by updating initialized values and constraint feedback responsive to refreshed derived features and refreshed timeline representation, a combination thereof and the like.

In some embodiments, responsive to designation of the affected calculator definition, the monitoring and update service 200 is configured to cause the calculator interface generation engine 165 to refresh prediction outputs for one or more stored input value sets.

In some embodiments, the monitoring and update service 200 is configured to cause the calculator interface generation engine 165 to construct an updated model feature representation using the refreshed matter context record and an input value set stored in a prediction record, to obtain an updated model output from the predictive model, to obtain an updated calibrated prediction output from the calibration service 175, and to provide an updated prediction output to the calculator rendering service 160 for presentation, a combination thereof and the like.

In some embodiments, the monitoring and update service 200 is configured to store an update record in the internal repository 145 that associates the updated prediction output with the affected calculator definition and the refreshed matter context record, a combination thereof and the like.

In some embodiments, the monitoring and update service 200 is configured to generate an update notification for presentation within the interactive calculator interface. In some embodiments, the update notification identifies a changed source system, an identifier of an additional batch manifest, a summary of refreshed canonical entities and refreshed derived features, and a list of prediction outputs affected by the refreshed matter context record, a combination thereof and the like. In some embodiments, the update notification includes provenance links and audit block references sufficient to support defensibility of the update, a combination thereof and the like.

In some embodiments, an administration and configuration service 205 is configured to manage configuration of system artifacts persisted by the context & governance service 130, where the system artifacts include calculator templates, validated calculator definitions, ontology rule tables, jurisdictional mapping tables, calibration mappings, access scope attributes, data-handling constraints, retention-class labels, a combination thereof and the like. In some embodiments, the administration and configuration service 205 is configured to present an administration interface that enables an administrator principal to create, review, update, and retire configuration artifacts under attribute-based rules enforced by the context & governance service 130, a combination thereof and the like.

In some embodiments, the administration and configuration service 205 is configured to manage a calculator template repository maintained by the context & governance service 130. In some embodiments, management includes creating a calculator template that includes a calculator definition specifying input field names, input field types, permitted value ranges, required-field constraints, inter-field consistency rules, computational relationships, and output visualization bindings, a combination thereof and the like. In some embodiments, management further includes associating the calculator template with eligibility data that identifies jurisdiction-aware identifiers, procedural stage labels, and derived feature prerequisites represented by canonical entities and derived features produced by the ontology service 120, a combination thereof and the like. In some embodiments, management further includes storing each calculator template as a versioned artifact together with an approval status history and review comments persisted by the collaboration and review service 190, a combination thereof and the like.

In some embodiments, the administration and configuration service 205 is configured to manage ontology configuration artifacts used by the ontology service 120. In some embodiments, management includes creating and updating ontology rule tables that define ontology classes, relations, and feature derivation rules, a combination thereof and the like, and creating and updating jurisdictional mapping tables that map source-specific labels to standardized identifiers, a combination thereof and the like. In some embodiments, management includes associating each ontology configuration artifact with provenance links that reference sources used to construct the ontology configuration artifact and with audit blocks that capture version changes, a combination thereof and the like.

In some embodiments, the administration and configuration service 205 is configured to manage calibration configuration artifacts used by the calibration service 175. In some embodiments, management includes creating a calibration cohort definition that identifies a cohort using jurisdiction-aware identifiers represented by canonical entities, procedural stage labels represented in the timeline representation, and claim-related labels represented in canonical entities and ontology classes, a combination thereof and the like. In some embodiments, management further includes creating and updating a calibration mapping that transforms a model output into a calibrated prediction output for the calibration cohort, and store the calibration mapping in the internal repository 145 with a version identifier and provenance links, a combination thereof and the like.

In some embodiments, the administration and configuration service 205 is configured to manage governance configuration artifacts. In some embodiments, management includes defining access scope attributes and attribute-based rules that govern access to matter context records, calculator definitions, prediction records, scenario analysis records, and report packages, a combination thereof and the like. In some embodiments, management further includes defining data-handling constraints that specify redaction rules, pseudonymous identifier rules, retention-class labels, and encryption requirements enforced during storage and presentation of artifacts, a combination thereof and the like. In some embodiments, the administration and configuration service 205 is configured to persist governance configuration artifacts as versioned artifacts with audit blocks and approval status history, a combination thereof and the like.

In some embodiments, the administration and configuration service 205 is configured to support controlled deployment of configuration artifacts. In some embodiments, controlled deployment includes selecting a deployment scope corresponding to a set of principals, a set of matters, a set of jurisdictions, a combination thereof and the like, and associating configuration artifact versions with the deployment scope in the internal repository 145. In some embodiments, controlled deployment further includes generating a deployment record that identifies configuration artifact versions included in a deployment and provenance links that reference audit blocks for the configuration artifact versions, a combination thereof and the like.

In some embodiments, an integration and delivery service 210 is configured to deliver artifacts produced by the system to one or more external destination systems associated with an enterprise environment, where the artifacts include a report package produced by the report generation service 195, prediction outputs presented through the interactive calculator interface rendered by the calculator rendering service 160, scenario analysis records produced by the scenario analysis service 185, and review provenance packages produced by the collaboration and review service 190, a combination thereof and the like. In some embodiments, the integration and delivery service 210 is configured to obtain a delivery request that identifies an artifact identifier, an artifact version identifier, a destination system identifier, and access scope attributes associated with a requesting principal, a combination thereof and the like.

In some embodiments, the integration and delivery service 210 is configured to verify delivery eligibility prior to delivery. In some embodiments, verification includes verifying that the requesting principal is authorized for the artifact identifier under attribute-based rules, verifying that the artifact version identifier corresponds to an approved status when the artifact is a validated calculator definition and a report package, verifying that data-handling constraints, permit inclusion of selected fields in a delivery payload, a combination thereof and the like. In some embodiments, the integration and delivery service 210 is configured to generate a delivery profile that specifies a field inclusion set, a redaction rule set, and a pseudonymous identifier rule set applied to the delivery payload, a combination thereof and the like.

In some embodiments, the integration and delivery service 210 is configured to construct a delivery payload for the destination system. In some embodiments, construction includes selecting content from a report package, selecting a prediction output presented through the interactive calculator interface together with a calibrated prediction output and a model output associated with the prediction output, and selecting a provenance subset that includes provenance links and audit block references sufficient to support defensibility, a combination thereof and the like. In some embodiments, the integration and delivery service 210 is configured to apply the delivery profile by redacting restricted fields, substituting pseudonymous identifiers, and excluding restricted provenance links according to attribute-based rules, a combination thereof and the like.

In some embodiments, the integration and delivery service 210 is configured to deliver the delivery payload to the destination system through an external integration connector. In some embodiments, the external integration connector includes a connector that writes to a document-management repository, a connector that writes to a matter-management repository, a connector that writes to an electronic billing system, a connector that writes to an enterprise messaging system, and a connector that writes to an enterprise analytics repository, a combination thereof and the like. In some embodiments, the integration and delivery service 210 is configured to deliver the delivery payload by generating a destination-specific record that includes a destination object identifier returned by the destination system and by associating the destination object identifier with the artifact identifier and the artifact version identifier in the internal repository 145, a combination thereof and the like.

In some embodiments, the integration and delivery service 210 is configured to record a delivery record in the internal repository 145. In some embodiments, the delivery record includes the delivery request, the delivery profile, an identifier of the destination system, a destination object identifier, a timestamp, and provenance links that reference the artifact identifier, the artifact version identifier, batch manifests, and record-level cryptographic digest values computed over record contents, a combination thereof and the like. In some embodiments, the internal repository 145 is configured to store the delivery record as a versioned artifact and to associate the delivery record with audit blocks that record authorization decisions and field-level redaction actions, a combination thereof and the like.

In some embodiments, the integration and delivery service 210 is configured to support subsequent update delivery responsive to an updated matter context record produced by the monitoring and update service 200. In some embodiments, subsequent update delivery includes identifying a previously delivered artifact identifier and destination object identifier, reconstructing a refreshed delivery payload that reflects updated prediction outputs and refreshed report packages, and transmitting the refreshed delivery payload to the destination system under the same delivery profile and access scope attributes, a combination thereof and the like. In some embodiments, the integration and delivery service 210 is configured to persist an additional delivery record that associates the refreshed delivery payload with the updated matter context record and an updated artifact version identifier, a combination thereof and the like.

In some embodiments, a model governance service 215 is configured to manage lifecycle governance for a predictive model and a calibration service 175 used to generate prediction outputs presented through the interactive calculator interface rendered by the calculator rendering service 160, a combination thereof and the like. In some embodiments, the model governance service 215 is configured to obtain, from the context & governance service 130, prediction records, scenario analysis records, validation results, approval status histories, and provenance links associated with prediction outputs, a combination thereof and the like, and to use the obtained artifacts to evaluate predictive performance and calibration performance across cohorts.

In some embodiments, the model governance service 215 is configured to define an evaluation cohort that partitions prediction records using jurisdiction-aware identifiers represented by canonical entities, procedural stage labels represented in the timeline representation, claim-related labels represented in canonical entities and ontology classes, and time-window labels derived from batch manifests, a combination thereof and the like. In some embodiments, the model governance service 215 is configured to compute evaluation measures for the evaluation cohort by comparing model outputs and calibrated prediction outputs to observed outcomes recorded in outcome records persisted in the context & governance service 130, a combination thereof and the like. In some embodiments, the observed outcomes include disposition outcomes, settlement outcomes, award outcomes, and time-to-event outcomes, a combination thereof and the like.

In some embodiments, the model governance service 215 is configured to generate a calibration assessment that characterizes whether calibrated prediction outputs satisfy a calibration criterion for the evaluation cohort. In some embodiments, the calibration criterion includes a deviation measure between calibrated prediction outputs and observed outcome frequencies for a plurality of probability bands, and a coverage measure that characterizes reliability of calibrated prediction outputs for the evaluation cohort, a combination thereof and the like. In some embodiments, the model governance service 215 is configured to persist the calibration assessment in the internal repository 145 with lineage to the evaluation cohort definition and provenance links that reference batch manifests and record-level cryptographic digest values computed over record contents, a combination thereof and the like.

In some embodiments, the model governance service 215 is configured to detect drift in prediction outputs. In some embodiments, drift detection includes comparing distributions of model feature representations and model outputs across time windows derived from batch manifests, comparing distributions across jurisdiction-aware identifiers and procedural stage labels, and detecting a difference that exceeds a drift threshold, a combination thereof and the like. In some embodiments, the model governance service 215 is configured to generate a drift report that identifies affected cohorts, affected derived features, and affected canonical entities, together with provenance links and audit blocks sufficient to support defensibility of the drift report, a combination thereof and the like.

In some embodiments, responsive to a calibration assessment that fails the calibration criterion and responsive to drift detection that exceeds the drift threshold, the model governance service 215 is configured to initiate a calibration update workflow. In some embodiments, the calibration update workflow includes generating an updated calibration mapping for a calibration cohort definition managed by the administration and configuration service 205, validating the updated calibration mapping against validation datasets, and associating the updated calibration mapping with an approval status history managed by the collaboration and review service 190, a combination thereof and the like. In some embodiments, responsive to approval of the updated calibration mapping, the model governance service 215 is configured to cause the calibration service 175 to apply the updated calibration mapping to subsequent model outputs to generate subsequent calibrated prediction outputs, a combination thereof and the like. In some embodiments, the validation datasets are retrieved from the internal repository 145.

In some embodiments, responsive to drift detection that exceeds the drift threshold, the model governance service 215 is configured to initiate a predictive model update workflow. In some embodiments, the predictive model update workflow includes selecting training data from historical matters represented using canonical entities, derived features, procedural stage labels, and outcome labels, a combination thereof and the like, training an updated predictive model by updating parameters to reduce an error measure between model outputs and observed outcomes, and validating the updated predictive model using held-out matters persisted by the context & governance service 130, a combination thereof and the like. In some embodiments, the model governance service 215 is configured to associate the updated predictive model with a model identifier, a version identifier, and an approval status history managed by the collaboration and review service 190, a combination thereof and the like.

In some embodiments, the model governance service 215 is configured to persist a model governance record in the internal repository 145. In some embodiments, the model governance record includes evaluation cohort definitions, evaluation measures, calibration assessments, drift reports, identifiers, versions for calibration mappings, identifiers and versions for predictive models, approval status histories associated with deployments, a combination thereof and the like. In some embodiments, the model governance record includes provenance links that reference batch manifests, record-level cryptographic digest values computed over record contents, audit blocks that record authorization decisions, and delivery records that associate prediction outputs to destination systems, a combination thereof and the like.

In some embodiments, the system keys deployed bundles and related artifacts by a deterministic hash computed over a canonicalized representation of a calculator definition (or schema/manifest) and, optionally, over selected configuration identifiers (e.g., model version identifier, calibration mapping identifier). In some embodiments, responsive to receiving a subsequent request to render the calculator interface for the same calculator definition, the system reuses a previously deployed bundle identified by the hash and bypasses recompilation, thereby reducing latency for repeated launches. In some embodiments, the system applies time-to-live (TTL) and invalidation rules such that a new bundle is generated when the calculator definition changes, when an approval status transitions, or when a governed configuration artifact changes, a combination thereof and the like.

In some embodiments, an event bus is utilized to synchronize calculator state, annotations, and scenario state across a plurality of user devices and backend services in real time. In some embodiments, the event bus includes a publish-subscribe messaging system and/or a persistent WebSocket channel through which the interactive calculator interface transmits state updates and receives merged state updates. In some embodiments, the event bus transports messages that include field-change events, scenario-update events, annotation events, and prediction-update events, each message including a matter identifier, a calculator instance identifier, and a version indicator, a combination thereof and the like.

In some embodiments, synchronization of edits and merged state updates is transported via the event bus that includes a publish-subscribe messaging system, a persistent WebSocket channel, a combination thereof and the like.

In some embodiments, the interactive calculator interface performs optimistic updates by immediately updating a user-facing value responsive to a local edit and subsequently reconciling the local edit against an authoritative merged state received from the event bus. In some embodiments, conflict resolution is performed using operation identifiers that preserve causal ordering and by applying merge rules that deterministically resolve concurrent edits to the same field. In some embodiments, conflict resolution includes detecting that a prediction evaluation was initiated using stale input values and, responsive to the detection, canceling or deprioritizing a stale prediction task and re-issuing prediction evaluation using the merged state, thereby maintaining consistency between displayed prediction outputs and the authoritative calculator state.

In some embodiments, to satisfy interactive latency thresholds, the system caches intermediate artifacts for prediction evaluation. In some embodiments, cached artifacts include a model feature representation produced from current calculator inputs and structured legal matter data, a calibrated prediction output produced by applying a calibration mapping, and/or an explanation package that maps contribution magnitudes back to calculator fields, canonical entities, and derived features, a combination thereof and the like. In some embodiments, cache entries are indexed by a hash of input-field values and a matter identifier, and are invalidated responsive to receipt of a conflicting edit event, a configuration update event that changes a predictive model identifier, a calibration, a combination thereof and the like.

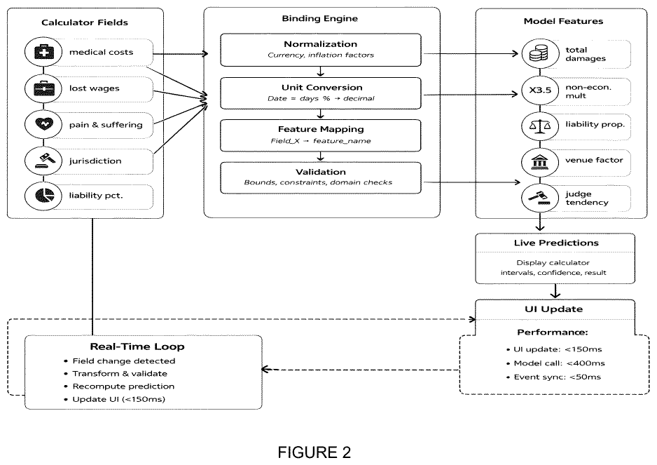

FIG. 2 is a diagram illustration of a data-binding flow, in accordance with an embodiment.

In some embodiments, the data-binding flow connects calculator inputs rendered in an interactive calculator interface to a predictive model that generates a model output, a calibrated prediction output, and a prediction output.

In some embodiments, the interactive calculator interface includes a plurality of calculator fields that receive user-provided values, where the calculator fields include monetary fields, categorical fields, jurisdiction fields, and proportion fields, a combination thereof and the like. In some embodiments, responsive to receipt of a user-provided value for a calculator field, a binding service is configured to transform the user-provided value and associated matter context information into model-ready feature values for consumption by the predictive model.

In some embodiments, the binding service is configured to perform normalization of calculator-field values by converting semantically equivalent representations into a standardized representation used for downstream feature construction. In some embodiments, normalization includes applying currency standardization, applying inflation adjustment factors, applying rounding and precision rules, and associating a time reference used for normalization with an underlying timeline representation of procedural events, a combination thereof and the like. In some embodiments, the binding service is configured to perform unit conversion by converting user-facing units into model-facing units, where unit conversion includes converting dates to durations expressed as day counts, converting percentages to decimal proportions, converting formatted monetary strings into numeric values, a combination thereof and the like.

In some embodiments, the binding service is configured to perform feature mapping that associates one and more calculator fields to one and more model features. In some embodiments, the feature mapping is based on a feature map. In some embodiments, feature mapping includes identifying a mapping entry in the feature map that links a calculator field to a model feature name, selecting one and more transformation rules associated with the mapping entry, and generating a model feature value by applying the transformation rules to the normalized value and to related information represented in structured legal matter data, a combination thereof and the like. In some embodiments, the structured legal matter data includes canonical entities and derived features, and the binding service applies a feature map that associates calculator fields to the canonical entities and the derived features to obtain additional feature values such as venue factors, judge tendency values, liability proportions, non-economic multipliers, total damages estimates, a combination thereof and the like.

In some embodiments, the binding service is configured to perform validation prior to providing model feature values to the predictive model. In some embodiments, validation includes enforcing permitted value ranges for calculator fields, enforcing required-field constraints, enforcing inter-field consistency rules, and performing domain checks that confirm that a jurisdiction field value is consistent with one and more jurisdictional attributes represented in the structured legal matter data, a combination thereof and the like. In some embodiments, responsive to a detected validation failure, the interactive calculator interface presents constraint feedback that identifies an affected calculator field and a violated constraint.

In some embodiments, after feature mapping and validation, the binding service provides a model feature representation to the predictive model, and the predictive model generates a model output based on the model feature representation. In some embodiments, a calibration mapping is selected using cohort information represented in the structured legal matter data, and the calibration mapping transforms the model output into a calibrated prediction output. In some embodiments, a presented prediction output is generated by formatting the calibrated prediction output according to output visualization bindings specified by a calculator definition, where the output visualization bindings define a displayed result, displayed confidence information, displayed intervals, a combination thereof and the like.

In some embodiments, the data-binding flow is performed in a real-time loop in which field changes trigger repeated transformation, mapping, model evaluation, and interface update. In some embodiments, the real-time loop includes detecting a field change, re-generating one and more affected model feature values, re-generating the model output and the calibrated prediction output, and updating the prediction output presented in the interactive calculator interface. In some embodiments, the real-time loop operates under latency thresholds that include a user-interface update threshold and a model-evaluation threshold, and the system records timing measurements for field-change handling, model evaluation, and interface update to maintain responsiveness during interactive use, a combination thereof and the like.

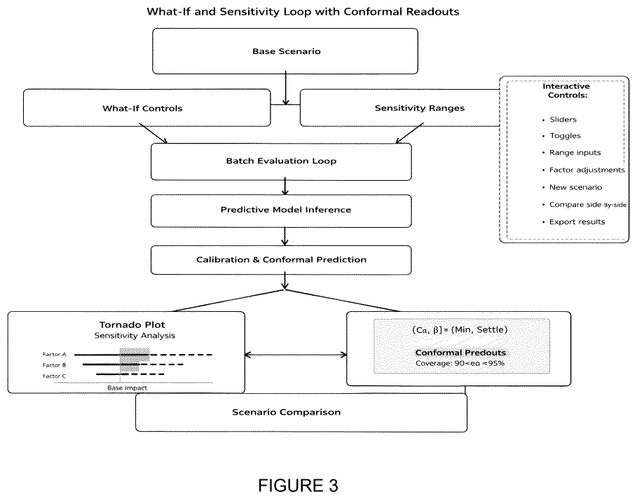

FIG. 3 is a diagram illustration of a what-if and sensitivity loop, in accordance to an embodiment.

In some embodiments, the what-if and sensitivity loop generates a plurality of scenario-specific-prediction outputs.

In some embodiments, the plurality of scenario-specific prediction outputs are each included with conformal readouts produced from calibrated prediction outputs. In some embodiments, a base scenario is established from user-provided values received through an interactive calculator interface rendered from a calculator definition and from values obtained from structured legal matter data, a combination thereof and the like. In some embodiments, the base scenario is used as a reference for generating a plurality of alternative scenarios defined by what-if controls and sensitivity ranges.

In some embodiments, the interactive calculator interface presents what-if controls and sensitivity ranges as interactive controls that include sliders, toggles, range inputs, factor adjustments, and scenario creation inputs, a combination thereof and the like. In some embodiments, user interaction with the interactive controls modifies at least one input field specified by the calculator definition, and the modified input field value is propagated through one and more computational relationships specified by the calculator definition to generate scenario-specific input values.

In at least one embodiment, the base scenario includes calculator inputs.

In at least one embodiment, the what-if controls include user adjusted parameters.

In at least one embodiment, the sensitivity controls define sweep parameters.

In some embodiments, a batch evaluation loop is performed in which a plurality of scenarios is enumerated by selecting values within the sensitivity ranges and by applying what-if adjustments to one and more input fields, and each enumerated scenario is evaluated to generate a scenario-specific prediction output.

In some embodiments, for each enumerated scenario, a model feature representation is constructed based on scenario-specific input values and structured legal matter data. In some embodiments, a predictive model processes the model feature representation to generate a model output for the scenario. In some embodiments, the model output is transformed into a calibrated prediction output using a calibration mapping selected based on at least a subset of the structured legal matter data. In some embodiments, a prediction output is generated by formatting the calibrated prediction output according to output visualization bindings specified by the calculator definition, and the prediction output is rendered within the interactive calculator interface for the scenario, a combination thereof and the like.

In some embodiments, conformal readouts are produced from calibrated prediction outputs. In some embodiments, conformal readouts include a predicted interval, a pair of bounds associated with a decision option, and a coverage indicator that characterizes reliability of the conformal readouts. In some embodiments, the conformal readouts are determined by applying a conformal procedure to calibrated prediction outputs for the plurality of scenarios, where the conformal procedure selects a nonconformity score based on residual behavior observed in a calibration cohort selected using structured legal matter data, and computes interval bounds responsive to a target coverage, a combination thereof and the like.

In some embodiments, sensitivity analysis and scenario comparison views are generated from the plurality of scenario-specific prediction outputs. In some embodiments, a tornado plot is generated by ranking scenario dimensions according to a magnitude of change in prediction outputs responsive to changes in corresponding input fields within the sensitivity ranges. In some embodiments, a scenario comparison view is generated that presents base scenario prediction outputs together with alternative scenario prediction outputs, conformal readouts, and the corresponding scenario-specific input values that differ from the base scenario. In some embodiments, the scenario comparison view is updated responsive to user interaction with the what-if controls, thereby enabling iterative sensitivity exploration within the interactive calculator interface, a combination thereof and the like.

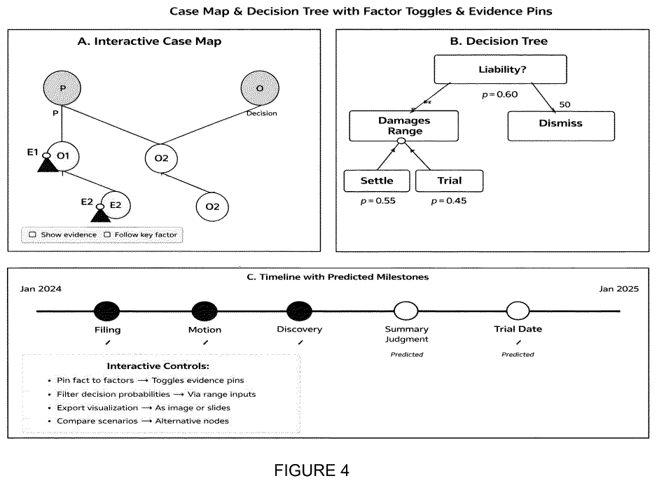

FIG. 4 is a diagram illustration of a case map and decision tree, in accordance with an embodiment.

In some embodiments, output visualization bindings are rendered within the interactive calculator interface by the calculator rendering service 160 using a validated calculator definition stored in the context & governance service 130. In some embodiments, the output visualization bindings specify presentation of a case map visualization, a decision-tree visualization, and a timeline visualization, where the presented content is derived from canonical entities, derived features, and a timeline representation of procedural events with stage labels represented in a matter context record, together with a prediction output generated from a calibrated prediction output produced by the calibration service 175 and explanatory information produced by the explanation service 180, a combination thereof and the like.

In some embodiments, the case map and decision tree includes a panel A, panel B, panel C, a combination thereof and the like.

In some embodiments, the panel A includes an interactive case map in which nodes correspond to canonical entities represented in the matter context record, where the canonical entities include parties, claims, legal elements, and evidence references, a combination thereof and the like. In some embodiments, links between nodes correspond to relations represented in an ontology-aligned dataset stored in the context & governance service 130, where the relations indicate associations between a party and a claim, associations between a claim and a legal element, and associations between a legal element and an evidence reference, a combination thereof and the like. In some embodiments, evidence pins displayed on the case map are generated by associating one or more canonical entities to provenance links that reference source materials within the plurality of legal documents using batch manifests and record-level cryptographic digest values computed over record contents, such that selection of an evidence pin presents a citation panel that identifies a source document reference, a location indicator within the source document, and a provenance reference stored by the context & governance service 130, a combination thereof and the like. In some embodiments, the interactive calculator interface includes one or more toggles that control visibility of evidence pins and visibility of key factors, where key factors correspond to contributing factors identified by the explanation service 180 and mapped back to calculator input fields, canonical entities, and derived features using the feature map and the ontology-aligned dataset, a combination thereof and the like.

In some embodiments, the panel B includes a decision-tree visualization that presents outcome pathways and calibrated likelihood values associated with the outcome pathways. In some embodiments, the decision-tree visualization is generated by selecting a set of split conditions from among calculator input fields and derived features that satisfy an importance criterion, where the importance criterion is determined using contribution magnitudes produced by the explanation service 180 for a current prediction output, a combination thereof and the like. In some embodiments, each branch of the decision-tree visualization is assigned a calibrated likelihood value by constructing a branch-specific model feature representation using branch-specific values for the set of split conditions together with remaining values from the current interactive calculator interface, generating a model output for the branch-specific model feature representation via the predictive model, and transforming the model output into a calibrated prediction output via a calibration mapping selected for a calibration cohort identified from the matter context record, a combination thereof and the like. In some embodiments, the decision-tree visualization is updated responsive to an input change within the interactive calculator interface by performing the update sequence described herein for generating a model output, generating a calibrated prediction output, and presenting an updated prediction output according to the output visualization bindings, a combination thereof and the like.

In some embodiments, the panel C includes a timeline visualization that combines observed procedural events with predicted milestones. In some embodiments, the observed procedural events are obtained from the timeline representation of procedural events with stage labels stored in the matter context record, where the timeline representation is derived from dated events identified within the plurality of legal documents and normalized into stage labels by the ontology service 120, a combination thereof and the like. In some embodiments, the predicted milestones include predicted dates for one or more future procedural events and predicted time-to-event values, where the predicted milestones are generated by constructing a model feature representation that includes current user-provided values, derived features, and timeline attributes, generating a model output that includes a time-to-event value via the predictive model, transforming the model output into a calibrated prediction output, and presenting the calibrated prediction output as a prediction output within the timeline visualization, a combination thereof and the like. In some embodiments, the interactive calculator interface includes interactive controls that filter the timeline, adjust relative weighting of one or more date-related inputs, apply simulation by generating a plurality of scenario-specific prediction outputs using the scenario analysis service 185, link a timeline milestone to a scenario input field specified by the validated calculator definition, compare scenarios side-by-side, and store user annotations associated with a timeline milestone as review comments persisted in the context & governance service 130 with lineage to the validated calculator definition and the matter context record, a combination thereof and the like.

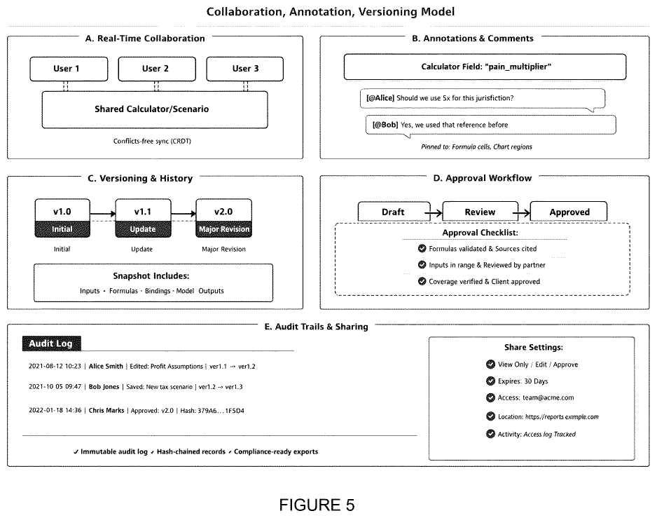

FIG. 5 is a diagram illustration of a collaboration, annotation and governance model, in accordance with an embodiment.

In some embodiments, the collaboration, annotation, and governance model for a shared interactive calculator interface rendered from a calculator definition. In some embodiments, a plurality of user devices access a shared calculator instance associated with a legal matter, where the shared calculator instance includes user-provided values for input fields, computational relationships, output visualization bindings, and one and more prediction outputs presented within the interactive calculator interface, a combination thereof and the like. In some embodiments, shared access is enforced using access scope attributes and data-handling constraints maintained by the context & governance service 130, and collaborative actions are recorded with provenance links and audit blocks to support defensibility.

In some embodiments, the collaboration, annotation and governance model for the shared interactive calculator includes a panel A, a panel B, a panel C, a panel D, a panel E, a combination thereof and the like.

In some embodiments, the panel A renders real-time collaboration in which a plurality of users concurrently edit the shared calculator instance and associated scenarios. In some embodiments, concurrent edits are synchronized using a conflict-free replication technique in which concurrent field updates are merged according to deterministic merge rules that preserve a convergent shared state across user devices. In some embodiments, the shared state includes current values of input fields and derived values produced by computational relationships defined in the calculator definition, and updates to the shared state trigger regeneration of a model feature representation and regeneration of a model output, a calibrated prediction output, and a prediction output as described herein.

In some embodiments, the panel B renders annotations and comments anchored to calculator content. In some embodiments, a review comment is associated with an artifact reference that identifies an input field, a computational relationship, an output visualization region, and a scenario comparison region, a combination thereof and the like. In some embodiments, a comment thread is persisted with reviewer identifiers, timestamps, and an association to a version identifier of the calculator definition, and the comment thread is rendered in proximity to the referenced calculator content within the interactive calculator interface. In some embodiments, the comment thread is further associated with provenance links that reference source materials within the plurality of legal documents used to generate structured legal matter data and derived features.

In some embodiments, in the panel C renders versioning and history for the shared calculator instance. In some embodiments, the system persists a sequence of versions for the calculator definition and the shared calculator instance, where each version is associated with a version identifier and a change description. In some embodiments, a snapshot associated with a version includes input field values, computational relationships, linkages that associate input fields to structured legal matter data, model output values, calibrated prediction output values, prediction output values, a combination thereof and the like. In some embodiments, snapshots are persisted as versioned artifacts with lineage to the calculator definition and to structured legal matter data used to initialize and bind the input fields.

In some embodiments, the panel D renders an approval workflow applied to the calculator definition and associated artifacts. In some embodiments, approval statuses include draft status, review status, approved status, and retired status. In some embodiments, a transition into approved status is conditioned on completion of an approval checklist that includes validation of constraints and computational relationships, confirmation that referenced sources are cited through provenance links, and verification that the prediction output includes coverage information associated with calibrated prediction output generation, a combination thereof and the like. In some embodiments, the approval workflow is implemented using review tasks and review task status indicators persisted with an approval status history.

In some embodiments, the panel E renders an audit trails and controlled sharing. In some embodiments, an audit log records edits, saves, and approvals for the shared calculator instance, where each log entry includes an actor identifier, an action identifier, a time value, and a version identifier, together with an integrity value computed over the stored artifact. In some embodiments, audit blocks are hash-chained such that each additional audit block references a preceding audit block, thereby enabling verification of an ordered sequence of edits. In some embodiments, share settings define permissions that include view permission, edit permission, and approve permission, together with an expiration constraint and an authorized recipient set identified by access scope attributes. In some embodiments, access activity is recorded as additional audit blocks associated with the shared artifact, and the shared artifact is delivered in a redacted form consistent with data-handling constraints enforced by the context & governance service 130.

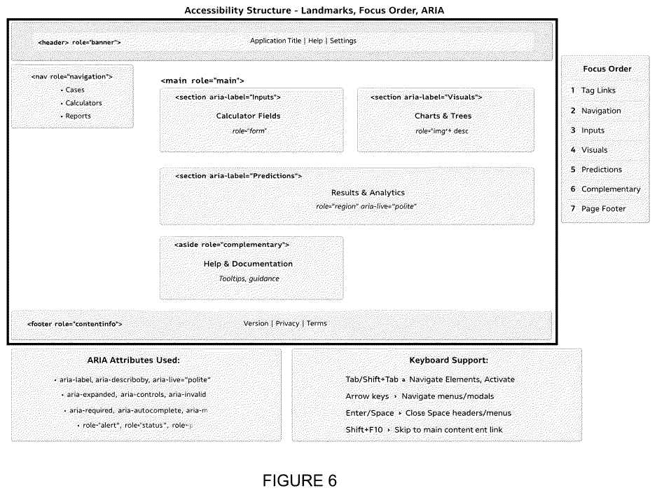

FIG. 6 is a diagram illustration of an accessibility structure, in accordance with an embodiment.

In some embodiments, the accessibility structure is for an interactive calculator interface rendered from a calculator definition, where the accessibility structure defines landmarks, focus order, and accessibility attributes for assistive technology interoperability. In some embodiments, the interactive calculator interface includes a header region, a navigation region, a main content region, a complementary region, and a footer region, and each region is identified using a role attribute that enables assistive technology to determine a semantic function of the region, a combination thereof and the like. In some embodiments, the accessibility structure is applied to user interface elements that present calculator fields, output visualization bindings, prediction outputs, and help content, thereby enabling keyboard navigation and screen reader interaction during use of the interactive calculator interface.

In some embodiments, the main content region includes a first section that presents input fields specified by the calculator definition and a second section that presents visual output elements corresponding to output visualization bindings specified by the calculator definition. In some embodiments, the first section is associated with an accessibility label that identifies the first section as an inputs region, and the input fields are associated with accessibility attributes that include label attributes, described-by attributes, expanded-state attributes, controls-reference attributes, invalid-state attributes, and required-state attributes, a combination thereof and the like. In some embodiments, the second section is associated with an accessibility label that identifies the second section as a visuals region, and each output visualization binding is associated with a role attribute and a descriptive attribute that provide a text description of a visualization element for assistive technology.

In some embodiments, the main content region further includes a predictions section that presents results and analytics derived from the calculator definition and from prediction outputs generated based on calibrated prediction outputs. In some embodiments, the predictions section is designated as a live region using an accessibility attribute that causes assistive technology to announce changes responsive to updates to prediction outputs, where updates occur responsive to receipt of user-provided values through input fields and responsive to recomputation of a model output and a calibrated prediction output. In some embodiments, the predictions section provides accessible text that identifies displayed values, displayed intervals, and displayed confidence information associated with the prediction outputs, a combination thereof and the like.

In some embodiments, the complementary region includes help and documentation content associated with the interactive calculator interface. In some embodiments, the help and documentation content includes tooltips and guidance associated with one and more input fields and one and more output visualization bindings. In some embodiments, the help and documentation content is associated with accessibility attributes that enable discovery through keyboard navigation and assistive technology traversal while preserving a consistent focus order across regions.

In some embodiments, a focus order defines a sequence in which interactive elements receive focus during keyboard navigation. In some embodiments, the focus order includes navigation to tag links, navigation controls, input fields, visualization elements, prediction output elements, complementary help elements, and footer elements. In some embodiments, keyboard support includes a tab traversal operation and a reverse tab traversal operation to move among focusable elements, arrow-key navigation within menus and modal controls, activation actions responsive to an enter input and a space input, and a skip-to-main-content action that transfers focus from a header region to the main content region, a combination thereof and the like.

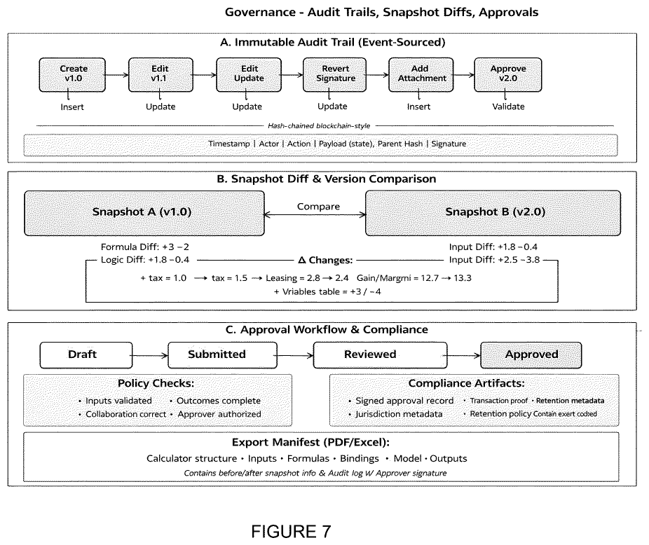

FIG. 7 is a diagram illustration of governance operations, in accordance with an embodiment.

In some embodiments, the governance operations are applied to calculator definitions, shared calculator instances, prediction records, scenario analysis records, and report packages, where the governance operations include immutable audit trails, snapshot comparison, and approval workflows. In some embodiments, the governance operations are enforced by the context & governance service 130 using access scope attributes, data-handling constraints, retention-class labels, and audit blocks, a combination thereof and the like. In some embodiments, governance artifacts generated in FIG. 7 enable verification of integrity, attribution, and lineage for prediction outputs presented within an interactive calculator interface.

In some embodiments, an immutable audit trail is implemented as an event-sourced sequence of audit blocks. In some embodiments, each audit block corresponds to an action applied to a governed artifact, where the action includes creation of a version of a calculator definition, editing of a prior version, applying an update, reverting a portion of a prior state, adding an attachment, and approving a version, a combination thereof and the like. In some embodiments, each audit block includes a timestamp, an actor identifier, an action identifier, and a payload that identifies a governed state associated with the action. In some embodiments, each audit block further includes a parent integrity value that references a preceding audit block and a signature value, thereby forming a hash-chained sequence in which modification of a prior audit block is detectable through integrity validation of the parent integrity value.

In some embodiments, snapshot comparison includes a first snapshot and a second snapshot. In some embodiments, the first snapshot corresponds to a first version identifier and the second snapshot corresponds to a second version identifier, and a comparison operation identifies differences between the first snapshot and the second snapshot. In some embodiments, differences include changes to calculator inputs, changes to computational relationships, changes to linkages that associate input fields to structured legal matter data, changes to derived features used during feature binding, changes to prediction outputs presented within the interactive calculator interface, a combination thereof and the like. In some embodiments, the comparison operation produces a diff record that identifies added items, removed items, and modified items, and associates each identified difference with an audit block that records an actor identifier and a timestamp for the change.

In some embodiments, an approval workflow includes transitions among draft status, submitted status, reviewed status, and approved status. In some embodiments, transition into an approved status is conditioned on completion of policy checks that include validation that required inputs are present and within permitted value ranges, validation that prediction outputs are complete for required scenarios, validation that collaboration and review comments satisfy review task status indicators, and validation that an approving principal is authorized under access scope attributes. In some embodiments, responsive to transition into approved status, the system generates compliance artifacts that include a signed approval record, jurisdiction metadata derived from structured legal matter data, retention metadata derived from data-handling constraints, and a transaction proof derived from the hash-chained audit blocks, a combination thereof and the like.

In some embodiments, an export manifest is generated responsive to an approved status. In some embodiments, the export manifest identifies a calculator structure, input values, computational relationships, linkages that associate input fields to structured legal matter data, model outputs, calibrated prediction outputs, prediction outputs, and associated diff records and audit blocks, a combination thereof and the like. In some embodiments, the export manifest includes before-and-after snapshot identifiers and an approver signature associated with the approved version identifier, thereby enabling downstream verification of integrity, authenticity, and lineage for the exported content.

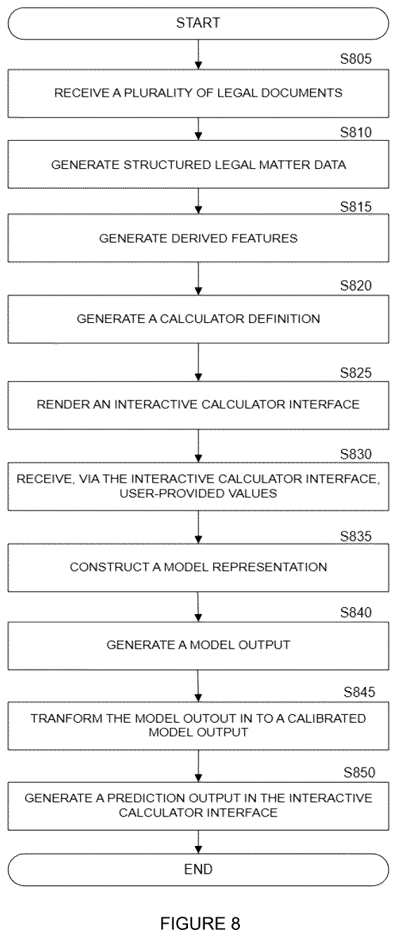

FIG. 8 is an example flowchart of a method for processing case-related electronic documents to generate a prediction output with an interactive calculator interface, implemented in accordance with an embodiment.

At S805, a plurality of legal documents are received. In some embodiments, the plurality of legal documents are received as electronic files. In some embodiments, the plurality of legal documents are associated with a legal matter. In some embodiments, receiving the plurality of legal documents includes associating each electronic file with a matter identifier that enables subsequent operations to reference the legal matter as a single unit of analysis.

For example, receiving the plurality of legal documents includes receiving pleadings, motions, orders, docket entries, correspondence, billing entries, and calendar entries associated with the legal matter, a combination thereof and the like. In some embodiments, receiving the plurality of legal documents includes receiving accompanying structured fields, including caption text, filing dates, docket numbers, author identifiers, document type labels, and jurisdiction indicators. In some embodiments, the received electronic files are stored with provenance information that enables later association between extracted information and source materials within the plurality of legal documents.

At S810, structured legal matter data is generated based on the received plurality of legal documents. In some embodiments, the structured legal matter data includes canonical entities. In some embodiments, generating the structured legal matter data includes identifying entity mentions within structured fields and text of the received plurality of legal documents and constructing candidate entities based on the entity mentions.

For example, the entity mentions include party names, counsel names, court identifiers, judicial-officer names, statute citations, venue strings, procedural event labels, and docket identifiers. In some embodiments, candidate entities are constructed by extracting the entity mentions from structured fields and text, applying normalization rules that standardize spelling and abbreviations, consulting reference registries that store standardized court identifiers and standardized judicial-officer identifiers, and merging duplicate mentions using similarity scores computed from normalized tokens and phonetic encodings. In some embodiments, candidate entities are promoted into canonical entities by assigning persistent identifiers, attaching jurisdictional attributes, and recording provenance links that associate each canonical entity with source materials within the plurality of legal documents.

At S815, derived features are generated. In some embodiments, the derived features are generated based on applying a jurisdiction-aware legal ontology to the received plurality of legal documents. In some embodiments, applying the jurisdiction-aware legal ontology includes aligning the canonical entities to ontology classes and relations defined by the jurisdiction-aware legal ontology.

For example, aligning the canonical entities includes associating canonical entities to ontology classes and relations, standardizing jurisdictional attributes associated with canonical entities that include court entities and venue entities, validating that each canonical entity associated with an ontology class satisfies required attributes specified for the ontology class, and recording provenance links that associate the aligning, the standardizing, and the validating with source materials within the plurality of legal documents. In some embodiments, generating the derived features includes evaluating ontology rules against aligned canonical entities, traversing relations among aligned canonical entities, projecting dated events into procedural stage labels, and generating numeric indicators and categorical labels used by downstream computations. In some embodiments, the derived features include exposure categories, damages archetypes, fee-shifting eligibility, venue attributes, limitation-period checkpoints, posture-at-filing indicators, and judge-profile attributes.

At S820, a calculator definition is generated based on the structured legal matter data. In some embodiments, the calculator definition specifies a plurality of input fields, at least one constraint for the plurality of input fields, at least one computational relationship among the plurality of input fields, and at least one output visualization binding. In some embodiments, generating the calculator definition includes defining which portions of the structured legal matter data initialize and update input fields and derived values during interactive use.

For example, generating the calculator definition includes selecting a pre-defined calculator template that is eligible for the legal matter based on structured legal matter data that includes jurisdictional attributes and procedural stage labels. In some embodiments, generating the calculator definition includes instantiating the pre-defined calculator template for the legal matter by binding at least a first subset of the plurality of input fields to canonical entities and binding at least a second subset of the plurality of input fields to derived features. In some embodiments, generating the calculator definition includes persisting binding identifiers that associate each bound input field with a corresponding canonical entity identifier and a corresponding derived feature identifier used during later feature binding.

At S825, an interactive calculator interface is rendered based on the calculator definition. In some embodiments, rendering the interactive calculator interface includes presenting the plurality of input fields and presenting one and more output visualization regions corresponding to the at least one output visualization binding. In some embodiments, rendering includes presenting a predictions region that presents the prediction output and updates responsive to changes in user-provided values.

For example, rendering the interactive calculator interface includes placing input fields in an inputs region, placing visualizations in a visuals region, placing prediction outputs in a predictions region, and placing help content in a complementary region. In some embodiments, rendering includes applying an accessibility structure that defines labeled regions and a focus order for keyboard navigation and assistive technology interoperability, including accessibility labels for the inputs region, the visuals region, and the predictions region. In some embodiments, the predictions region is designated as a live region that announces updates responsive to changes in the prediction output.

At S830, user-provided values are received through the interactive calculator interface. In some embodiments, the user-provided values are for at least a subset of the plurality of input fields. In some embodiments, receipt of a user-provided value initiates regeneration of one and more dependent field values determined by the at least one computational relationship and initiates regeneration of a prediction output.

For example, receiving user-provided values includes receiving numeric values, categorical selections, and proportion values for corresponding input fields. In some embodiments, receiving user-provided values includes enforcing the at least one constraint by evaluating permitted value ranges, required-field constraints, and inter-field consistency rules against current user-provided values and presenting constraint feedback responsive to a detected constraint violation. In some embodiments, receiving user-provided values includes updating dependent fields responsive to changes in upstream fields by applying the at least one computational relationship, thereby maintaining consistency between displayed values and calculated values.

At S835, a model feature representation is constructed based on the user-provided values and the structured legal matter data. In some embodiments, constructing the model feature representation includes transforming calculator-facing values into model-facing feature values and assembling the model-facing feature values into a structured representation consumable by a predictive model.

For example, constructing the model feature representation includes normalizing user-provided values into standardized representations, including currency standardization and inflation adjustment for monetary values. In some embodiments, constructing the model feature representation includes unit conversion, including converting percentages to decimal proportions and converting dates to durations expressed as day counts. In some embodiments, constructing the model feature representation includes feature mapping that associates normalized values to model feature names and derives additional feature values using canonical entities and derived features represented in the structured legal matter data. In some embodiments, constructing the model feature representation includes validation of feature values by enforcing bounds checks and domain checks that confirm consistency between jurisdictional attributes represented in user-provided values and jurisdictional attributes represented in the structured legal matter data.

At S840, a model output is generated, via a predictive model, based on the model feature representation. In some embodiments, generating the model output includes providing the model feature representation as input to the predictive model and receiving the model output as a computed result for the legal matter under the user-provided values.

For example, the model output includes a numeric score, a probability value, a risk category label, and a time-to-event value, a combination thereof and the like. In some embodiments, generating the model output is performed responsive to each detected change in a user-provided value, such that an interactive loop is supported in which feature construction and model evaluation are repeated, and the interactive calculator interface is updated with a refreshed prediction output.

At S845, the model output is transformed into a calibrated prediction output. In some embodiments, the transformation includes using a calibration mapping selected based on at least a subset of the structured legal matter data. In some embodiments, the calibrated prediction output expresses a calibrated value that is more consistent with observed outcome frequencies for a cohort selected using structured legal matter data.

For example, selecting the calibration mapping includes selecting a calibration cohort using jurisdictional attributes, court identifiers, judicial-officer identifiers, claim types, and procedural stage labels represented in the structured legal matter data. In some embodiments, transforming the model output includes applying the calibration mapping to generate the calibrated prediction output and generating coverage information that characterizes reliability of calibrated prediction outputs for the selected calibration cohort. In some embodiments, the coverage information is used to generate conformal readouts that include an interval bound and a coverage indicator for the calibrated prediction output.

At S850, the prediction output is generated based on the calibrated prediction output. In some embodiments, the prediction output is presented within the interactive calculator interface according to the at least one output visualization binding. In some embodiments, generating the prediction output includes formatting values for presentation and updating the predictions region responsive to changes in user-provided values.

For example, generating the prediction output includes formatting the calibrated prediction output for presentation as a displayed result, a displayed interval, and displayed confidence information within the predictions region. In some embodiments, generating the prediction output includes generating an explanation package that includes contributing factors and contribution magnitudes mapped to the plurality of input fields and the derived features and presenting the explanation package in association with the prediction output. In some embodiments, generating the prediction output includes persisting a prediction record that associates the user-provided values, the model output, the calibrated prediction output, and the prediction output with provenance links that associate canonical entities and derived features to source materials within the plurality of legal documents.

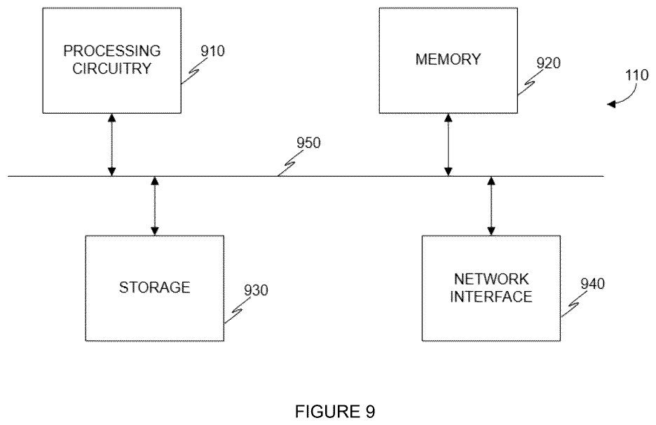

FIG. 9 is an example schematic diagram of a data ingestion pipeline 110 according to an embodiment. The data ingestion pipeline 110 includes, according to an embodiment, a processing circuitry 910 coupled to a memory 920, a storage 930, and a network interface 940. In an embodiment, the components of the data ingestion pipeline 110 are communicatively connected via a bus 950.

In certain embodiments, the processing circuitry 910 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 920 is a volatile memory (e.g., random access memory, etc.), a non-volatile memory (e.g., read only memory, flash memory, etc.), a combination thereof and the like. In some embodiments, the memory 920 is an on-chip memory, an off-chip memory, a combination thereof and the like. In certain embodiments, the memory 920 is a scratch-pad memory for the processing circuitry 910.

In one configuration, software for implementing one or more embodiments disclosed herein is stored in the storage 930, in the memory 920, in a combination thereof and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 910, cause the processing circuitry 910 to perform the various processes described herein, in accordance with an embodiment.

In some embodiments, the storage 930 is a magnetic storage, an optical storage, a solid-state storage, a combination thereof and the like, and is realized, according to an embodiment, as a flash memory, as a hard-disk drive, another memory technology, various combinations thereof, or any other medium which can be used to store the desired information.

The network interface 940 is configured to provide the data ingestion pipeline 110 with communication with, for example, user device, client device, graphical user interface, dashboard, a combination thereof and the like, according to an embodiment.

It should be understood that the embodiments described herein are not limited to the specific architecture illustrated in FIG. 9, and other architectures may be equally used without departing from the scope of the disclosed embodiments.

Furthermore, in certain embodiment an ontology service 120, a matter-entity model 122, a context & governance service 130, a calculator selection service 140, an internal repository 145, a calculator generation engine 150, a language-to-calculator model 152, a calculator validation service 155, a calculator rendering service 160, a calculator interface generation engine 165, a feature binding service 170, a calibration service 175, an explanation service 180, a scenario analysis service 185, a collaboration and review service 190, a report generation service 195, a monitoring and update service 200, an administration and configuration service 205, an integration and delivery service 210 and a model governance service 215, various combinations thereof, and the like, may be implemented with the architecture illustrated in FIG. 9. In other embodiments, other architectures may be equally used without departing from the scope of the disclosed embodiments.

As used herein, a language model refers to a computational model configured to process linguistic input and to generate, evaluate, or otherwise operate on sequences of linguistic units, such as characters, sub-words, words, tokens, symbols, or combinations thereof, by estimating probabilistic relationships among such units.

Language models, as described herein, may include large language models (LLMs), small language models (SLMs), and other neural or non-neural language modeling systems, without limitation as to model size, parameter count, architecture, or training methodology. Non-limiting examples of language models include transformer-based models such as GPT-family models, Claude-family models, BERT-family models, T5, BART, and derivatives or variants thereof, as well as functionally equivalent models developed in the future.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for processing case-related electronic documents to generate a prediction output within an interactive calculator interface, comprising:
receiving a plurality of legal documents as electronic files, wherein the plurality of legal documents are associated with a legal matter;
generating structured legal matter data based on the received plurality of legal documents, wherein the structured legal matter data includes canonical entities;
generating derived features by applying a jurisdiction-aware legal ontology to the received plurality of legal documents;
generating a calculator definition for the legal matter based on the structured legal matter data, wherein the calculator definition specifies a plurality of input fields, at least one constraint for the plurality of input fields, at least one computational relationship among the plurality of input fields, and at least one output visualization binding;
rendering the interactive calculator interface based on the calculator definition;
receiving, through the interactive calculator interface, user-provided values for at least a subset of the plurality of input fields;
constructing a model feature representation based on the user-provided values and the structured legal matter data;
generating a model output for the legal matter, via a predictive model, based on the model feature representation;
transforming the model output into a calibrated prediction output using a calibration mapping selected based on at least a subset of the structured legal matter data; and
generating the prediction output based on the calibrated prediction output, the prediction output being presented within the interactive calculator interface according to the at least one output visualization bindings.

2. The method of claim 1, further comprising:
normalizing the plurality of legal documents into normalized records that conform to a normalized intake schema, wherein the normalized intake schema specifies field names, field types, permitted value ranges, required-field constraints, and inter-field consistency rules applied during normalization; and
associating the normalized records with the legal matter.

3. The method of claim 1, further comprising:
identifying candidate entities using a matter-entity model, wherein the matter-entity model receives text blocks, captions, signatures, and header metadata derived from the plurality of legal documents as inputs and outputs text-span labels and relationship records, wherein the candidate entities are identified based on the output text-span labels; and
promoting the candidate entities into the canonical entities by assigning persistent identifiers and jurisdictional attributes, wherein the canonical entities include parties, counsel, courts, judicial officers, claims, statutes, venues, procedural events, and docket identifiers.

4. The method of claim 1, further comprising:
associating the canonical entities to ontology classes and relations defined by the jurisdiction-aware legal ontology, wherein at least one associated canonical entity includes courts and venues;
standardizing jurisdictional attributes with the at least one associated canonical entity, wherein the jurisdictional attributes include forum identifiers and division identifiers;
validating that each associated canonical entity satisfies required attributes specified for the ontology class; and
recording provenance links that associate the associated canonical entities, the standardized jurisdictional attributes and the validated associated canonical entities with the plurality of legal documents.

5. The method of claim 1, further comprising:
selecting a pre-defined calculator template; and
instantiating the pre-defined calculator template for the legal matter by binding at least a first subset of the plurality of input fields to the canonical entities and binding at least a second subset of the plurality of input fields to the derived features.

6. The method of claim 1, further comprising:
receiving a user request, wherein the user request includes a calculator objective;
generating the calculator definition based on the user request;
aligning a first subset of terminology in the user request to the canonical entities; and
aligning a second subset of terminology in the user request to ontology classes represented by the jurisdiction-aware legal ontology.

7. The method of claim 6, further comprising:
generating a structured calculator representation using a language-to-calculator model, wherein the user request and the structured legal matter data are inputs to the language-to-calculator model, the structured calculator representation enumerates candidate input fields; and
determining the plurality of input fields based on at least a subset of the candidate input fields.

8. The method of claim 1, further comprising:
presenting constraint feedback by evaluating the at least one constraint against current user-provided values and displaying a constraint violation indicator responsive to a detected constraint violation.

9. The method of claim 1, further comprising:
generating an explanation package associated with the prediction output, wherein the explanation package includes contributing factors and contribution magnitudes mapped to the plurality of input fields and the derived features.

10. A non-transitory computer-readable medium storing a set of instructions for processing case-related electronic documents to generate a prediction output within an interactive calculator interface, the set of instructions comprising:
one or more instructions that, when executed by one or more processing circuitries of a device, cause the device to:
receive a plurality of legal documents as electronic files, wherein the plurality of legal documents are associated with a legal matter;
generate structured legal matter data based on the received plurality of legal documents, wherein the structured legal matter data includes canonical entities;
generate derived features by applying a jurisdiction-aware legal ontology to the received plurality of legal documents;
generate a calculator definition for the legal matter based on the structured legal matter data, wherein the calculator definition specifies a plurality of input fields, at least one constraint for the plurality of input fields, at least one computational relationship among the plurality of input fields, and at least one output visualization binding;
render the interactive calculator interface based on the calculator definition;
receive, through the interactive calculator interface, user-provided values for at least a subset of the plurality of input fields;
construct a model feature representation based on the user-provided values and the structured legal matter data;
generate a model output for the legal matter, via a predictive model, based on the model feature representation;
transform the model output into a calibrated prediction output using a calibration mapping selected based on at least a subset of the structured legal matter data; and
generate the prediction output based on the calibrated prediction output, the prediction output being presented within the interactive calculator interface according to the at least one output visualization bindings.

11. A system for processing case-related electronic documents to generate a prediction output within an interactive calculator interface comprising:
a processing circuitry;
a memory, the memory containing instructions that, when executed by the processing circuitry, configure the system to:
receive a plurality of legal documents as electronic files, wherein the plurality of legal documents are associated with a legal matter;
generate structured legal matter data based on the received plurality of legal documents, wherein the structured legal matter data includes canonical entities;
generate derived features by applying a jurisdiction-aware legal ontology to the received plurality of legal documents;
generate a calculator definition for the legal matter based on the structured legal matter data, wherein the calculator definition specifies a plurality of input fields, at least one constraint for the plurality of input fields, at least one computational relationship among the plurality of input fields, and at least one output visualization binding;
render the interactive calculator interface based on the calculator definition;
receive, through the interactive calculator interface, user-provided values for at least a subset of the plurality of input fields;
construct a model feature representation based on the user-provided values and the structured legal matter data;
generate a model output for the legal matter, via a predictive model, based on the model feature representation;
transform the model output into a calibrated prediction output using a calibration mapping selected based on at least a subset of the structured legal matter data; and
generate the prediction output based on the calibrated prediction output, the prediction output being presented within the interactive calculator interface according to the at least one output visualization bindings.

12. The system of claim 11, wherein the memory contains further instructions which when executed by the processing circuitry further configure the system to:
normalize the plurality of legal documents into normalized records that conform to a normalized intake schema, wherein the normalized intake schema specifies field names, field types, permitted value ranges, required-field constraints, and inter-field consistency rules applied during normalization; and
associate the normalized records with the legal matter.

13. The system of claim 11, wherein the memory contains further instructions which when executed by the processing circuitry further configure the system to:
identify candidate entities using a matter-entity model, wherein the matter-entity model receives text blocks, captions, signatures, and header metadata derived from the plurality of legal documents as inputs and outputs text-span labels and relationship records, wherein the candidate entities are identified based on the outputs; and
promote the candidate entities into the canonical entities by assigning persistent identifiers and jurisdictional attributes, wherein the canonical entities include parties, counsel, courts, judicial officers, claims, statutes, venues, procedural events, and docket identifiers.

14. The system of claim 11, wherein the memory contains further instructions which when executed by the processing circuitry further configure the system to:
associate the canonical entities to ontology classes and relations defined by the jurisdiction-aware legal ontology, wherein at least one associated canonical entity includes courts and venues;
standardize jurisdictional attributes with the at least one associated canonical entity, wherein the jurisdictional attributes include forum identifiers and division identifiers;
validate that each associated canonical entity satisfies required attributes specified for the ontology class; and
record provenance links that associate the associated canonical entities, the standardized jurisdictional attributes and the validated associated canonical entities with the plurality of legal documents.

15. The system of claim 11, wherein the memory contains further instructions which when executed by the processing circuitry further configure the system to:
select a pre-defined calculator template; and
instantiate the pre-defined calculator template for the legal matter by binding at least a first subset of the plurality of input fields to the canonical entities and binding at least a second subset of the plurality of input fields to the derived features.

16. The system of claim 11, wherein the memory contains further instructions which when executed by the processing circuitry further configure the system to:
receive a user request, wherein the user request includes a calculator objective;
generate the calculator definition based on the user request;
align a first subset of terminology in the user request to the canonical entities; and
align a second subset of terminology in the user request to ontology classes represented by the jurisdiction-aware legal ontology.

17. The system of claim 16, wherein the memory contains further instructions which when executed by the processing circuitry further configure the system to:
generate a structured calculator representation using a language-to-calculator model, wherein the user request and the structured legal matter data are inputs to the language-to-calculator model, the structured calculator representation enumerates candidate input fields; and
determine the plurality of input fields based on at least a subset of the candidate input fields.

18. The system of claim 11, wherein the memory contains further instructions which when executed by the processing circuitry further configure the system to:
present constraint feedback by evaluating the at least one constraint against current user-provided values and displaying a constraint violation indicator responsive to a detected constraint violation.

19. The system of claim 11, wherein the memory contains further instructions which when executed by the processing circuitry further configure the system to:
generate an explanation package associated with the prediction output, wherein the explanation package includes contributing factors and contribution magnitudes mapped to the plurality of input fields and the derived features.
